(19) United States
(12) Patent Application Publication
(10) Pub. No.: US 2006/0082708 A1
(43) Pub. Date: Apr. 20, 2006

(54) Polarizing plate, method of producing a polarizing plate, and liquid crystal panel, liquid crystal television, and liquid crystal display apparatus all using the same

(75) Inventors: Junichi Nagase, Osaka (JP); Nao Murakami, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki (JP)

(21) Appl. No.: 11/248,339

(22) Filed: Oct. 13, 2005

(30) Foreign Application Priority Data
Oct. 19, 2004 (JP) 2004-304534

(51) Int. Cl. G02F 1/1337

(52) U.S. Cl. 349/124

(57) ABSTRACT

There is provided a polarizing plate including a polyimide layer on at least one side of a polarizer, the polarizing plate having excellent durability causing no peeling or floating of each film to be formed even in a high temperature and high humidity environment. The polarizing plate of the present invention includes a polarizer and a protective film attached to at least one side of the polarizer through an adhesive layer, in which: the protective film is a laminate film including a transparent film layer and a polyimide layer; and the polarizer and the protective film are attached together such that the polyimide layer opposes the polarizer.

### BACKGROUND OF THE INVENTION

1. Field of the Invention

The present invention relates to a polarizing plate having a polyimide layer, a method of producing a polarizing plate, a liquid crystal panel, a liquid crystal television, and a liquid crystal display apparatus.

2. Description of the Related Art

Liquid crystal display apparatuses are used for personal computers, clocks, watches, televisions, cell phones, measuring instruments for automobiles or machines, and the like, and are used in various indoor and outdoor environments. A liquid crystal display apparatus generally employ one or two polarizing plates. In general, a commercially available polarizing plate has a laminate structure in which a polarizer prepared by coloring polyvinyl alcohol film with iodine and stretching the resultant is sandwiched by two protective films each formed of a triacetylcellulose film. Examples of required properties for the polarizing plate include: excellent optical properties such as light transmittance, degree of polarization, and hue; thin shape and lightweight; and inexpensive. In addition, it is regarded important that the polarizing plate have excellent durability in that: the optical properties of the polarizing plate hardly change; and no peeling or floating of each laminated film occurs. However, a conventional polarizing plate used in a high temperature and high humidity environment has a problem in that: the polarizing plate is liable to shrink or degrade due to moisture absorption of a polarizer; and optical properties of the polarizing plate degrade.

In order to solve the above-described problems, there is disclosed a method of improving durability of a polarizing plate used in a high temperature and high humidity environment by using a hydrophobic film having low moisture content such as a polyimide-based resin film as a protective film for a polarizer (JP 2002-90546 A, for example). However, as described above, the polarizer employs hydrophilic polyvinyl alcohol film, and thus a hydrophobic film such as a polyimide-based resin film is hardly laminated on a surface of the polarizer. Further, even if the hydrophobic film can be laminated temporarily, there arises a problem of peeling or floating of each laminated film when the polarizing plate is used in a high temperature and high humidity environment. A method of improving adhesiveness between the polarizer and the polyimide-based resin is still unknown.

### SUMMARY OF THE INVENTION

The present invention has been made in view of solving the above-described problems, and an object of the present invention is to provide a polarizing plate including a polyimide layer on at least one side of a polarizer, the polarizing plate having excellent durability causing no peeling or floating of each film forming the polarizing plate even in a high temperature and high humidity environment. Another object of the present invention is to provide a polarizing plate having high optical properties for a long period of time even in a high temperature and high humidity environment, and a liquid crystal panel, a liquid crystal television, and a liquid crystal display apparatus all using the polarizing plate.

The inventors of the present invention have conducted intensive studies on adhesiveness between a polarizer and a polyimide film, and have found that the above-described object can be attained: by using as a protective film for a polarizer a laminate film including a polyimide layer provided on one side of a transparent film; and laminating the polarizer and the protective film through an adhesive layer such that a surface of the polyimide layer of the laminate film opposes one surface of the polarizer, to thereby complete the present invention.

A polarizing plate according to an embodiment of the present invention includes a polarizer and a protective film attached to at least one side of the polarizer through an adhesive layer, wherein: the protective film comprises a laminate film including a transparent film layer and a polyimide layer; and the polarizer and the protective film are attached together such that the polyimide layer opposes the polarizer.

In one embodiment of the invention, the polarizer includes a stretched polymer film containing as a main component a polyvinyl alcohol-based resin, which contains a dichromatic substance.

In another embodiment of the invention, the transparent film layer includes a polymer film containing as a main component a cellulose-based resin.

In still another embodiment of the invention, the protective film further includes an anchor coat layer between the transparent film layer and the polyimide layer.

In still another embodiment of the invention, the polyimide layer has a thickness of 1 to 10 μm.

In still another embodiment of the invention, the polyimide layer includes a film containing as a main component fluorine-containing polyimide.

In still another embodiment of the invention, the fluorine-containing polyimide includes polyimide containing a repeating unit represented by the formula (1):

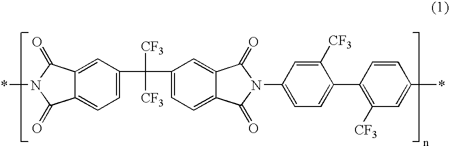

In still another embodiment of the invention, the polyimide layer has a light transmittance of 90% or more measured by using light of a wavelength of 590 nm at 23° C.

In still another embodiment of the invention, the polyimide layer has a thickness direction retardation value Rth[590] of 50 to 800 nm measured by using light of a wavelength of 590 nm at 23° C.

In still another embodiment of the invention, the adhesive layer includes a water-soluble adhesive containing as a main component modified polyvinyl alcohol having an acetoacetyl group.

According to another aspect of the invention, a method of producing a polarizing plate is provided. The method includes the steps of: applying a polyimide solution on a surface of a transparent film and drying the whole, so as to obtain a laminate film including a transparent film layer and a polyimide layer; and attaching the laminate film and a polarizer together through an adhesive such that the polyimide layer opposes the polarizer.

In one embodiment of the invention, the method further includes the step of subjecting a surface of the polyimide layer to modification treatment between the step of obtaining a laminate film and the step of attaching the laminate film and a polarizer together.

In another embodiment of the invention, the surface modification treatment includes at least one of corona treatment, glow discharge treatment, flame treatment, ozone treatment, UV/ozone treatment, UV treatment, and alkali treatment.

In still another embodiment of the invention, the adhesive includes a water-soluble adhesive containing as a main component modified polyvinyl alcohol having an acetoacetyl group.

In another embodiment of the invention, the polyimide layer is formed to have a thickness of 1 to 10 μm.

According to still another aspect of the invention, a liquid crystal panel is provided. The liquid crystal panel includes the above-described polarizing plate and a liquid crystal cell.

In one embodiment of the invention, the liquid crystal cell is of TN mode, VA mode, IPS mode, or OCB mode.

According to still another aspect of the invention, a liquid crystal television is provided. The liquid crystal television includes the above-described liquid crystal panel.

According to still another aspect of the invention, a liquid crystal display apparatus is provided. The liquid crystal display apparatus includes the above-described liquid crystal panel.

According to the present invention, a laminate film including a polyimide layer on one side of a transparent film layer is used as a protective film for a polarizer, to thereby provide a polarizing plate causing no peeling or floating across an entire surface even in a high temperature and high humidity environment. As a result, high optical properties of the polarizer such as light transmittance, degree of polarization, and hue can be maintained for a long period of time. Further, the polyimide layer is protected by a transparent film and is not exposed to outside air, to thereby prevent change in retardation values of the polyimide layer in a high temperature environment and prevent damages on a surface of the polyimide layer. Further, the retardation values of the polyimide layer may be appropriately controlled by a thickness of the polyimide layer, stretching treatment, or the like, to thereby improve contrast ratios in a normal direction and an oblique direction of a liquid crystal display apparatus of various drive modes. In a preferred embodiment of the present invention, the polyimide layer has a thickness of 1 to 10 μm. Such thickness may significantly improve durability of the polarizing plate in a high temperature and high humidity environment. Although not theoretically clarified, a very thin polyimide layer allows favorable adhesion between the polarizer (hydrophilic film) and the polyimide layer (hydrophobic film), which has conventionally been difficult. As a result, the polarizer can be protected by a polyimide layer having excellent thermal resistance and low moisture content. Further, favorable adhesiveness between the polyimide layer and the polarizer can be maintained for a long period of time, to thereby provide a polarizing plate having excellent durability.

### BRIEF DESCRIPTION OF THE DRAWINGS

In the accompanying drawings:

FIGS. 1A to 1F are each a schematic sectional view illustrating a polarizing plate according to a typical embodiment of the present invention.

FIG. 2 is a schematic diagram illustrating an overview of a typical production process of a polarizer used in the present invention.

FIG. 3 is a schematic diagram illustrating an overview of a polyimide solution application step and a surface modification treatment step in a production method of the present invention.

FIG. 4 is a schematic diagram exemplifying a case where the surface modification treatment step involves a wet process in a production method of the present invention.

FIG. 5 is a schematic diagram illustrating an overview of an attachment step of a laminate film and a polarizer in a production method of the present invention.

FIG. 6 is a schematic sectional view of a liquid crystal panel according to a preferred embodiment of the present invention.

FIGS. 7A to 7F are each a schematic perspective view illustrating a typical arrangement of a polarizing plate in a liquid crystal panel of the present invention.

FIG. 8 is a photograph comparing results of hot water tests of polarizing plates of Example 1 of the present invention and Comparative Example 1.

### DESCRIPTION OF THE PREFERRED EMBODIMENTS

A. Polarizing Plate

A-1. Overall Structure of Polarizing Plate

A polarizing plate of the present invention includes a polarizer and a protective film attached to at least one side of the polarizer through an adhesive layer, in which: the protective film is a laminate film including a transparent film layer and a polyimide layer; and the polarizer and the protective film are attached together such that the polyimide layer opposes the polarizer. Hereinafter, detailed description will be given of typical embodiments of an overall structure of the polarizing plate of the present invention by referring to drawings. Details of each member and each layer forming the polarizing plate are described later.

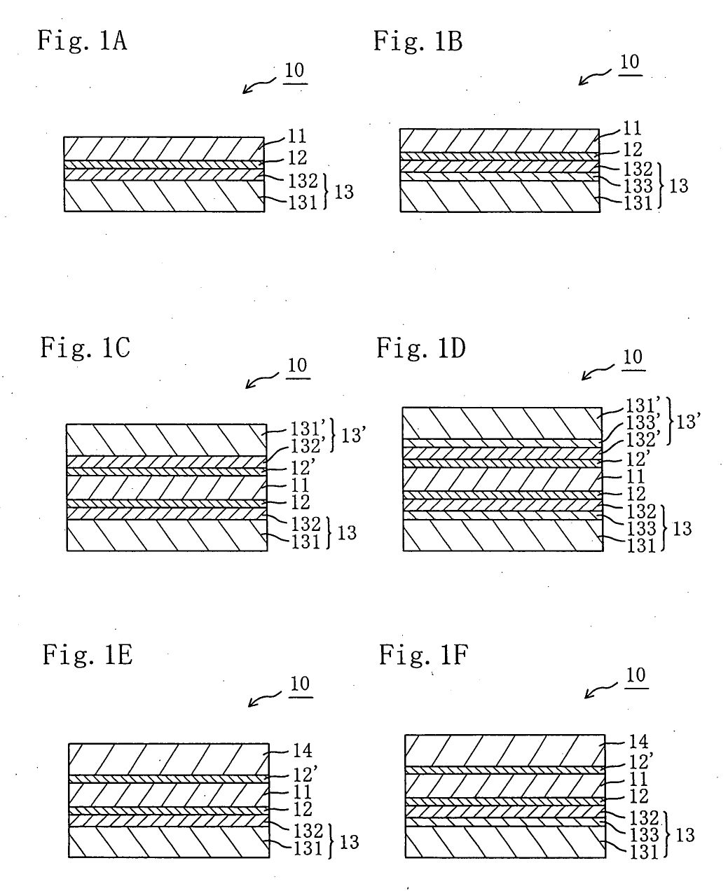

FIGS. 1A to 1F are each a schematic sectional view illustrating a polarizing plate according to a typical embodiment of the present invention. In an embodiment of the present invention as shown in FIG. 1A, a polarizing plate 10 is provide with: a polarizer 11; and a protective film 13 attached to one side of the polarizer 11 through an adhesive layer 12. The protective film 13 is a laminate film including a transparent film layer 131 and a polyimide layer 132 (hereinafter, such a protective film is referred to as laminate protective film). The polarizer 11 and the laminate protective film 13 are attached together such that the polyimide 132 opposes the polarizer 11 (that is, the polyimide layer 132 and the polarizer 11 are attached together through the adhesive layer 12). In a case where the transparent film layer and/or the polyimide layer exhibits retardation, the laminate protective film 13 may also serve as a retardation film.

In another embodiment as shown in FIG. 1B, the laminate protective film 13 further includes an anchor coat layer 133 between the transparent film layer 131 and the polyimide layer 132. The anchor coat layer 133 is provided, to thereby significantly improve adhesiveness and adhesive durability between the transparent film layer 131 and the polyimide layer 132. Embodiments shown in FIGS. 1A and 1B may contribute to reduction in thickness of a liquid crystal panel (eventually, a liquid crystal display apparatus).

In the present invention, the laminate protective film 13 may be provided only on one side of the polarizer 11, or may be provided on each side thereof. FIGS. 1C and 1D each illustrate an embodiment where the laminate protective film 13 is provided on each side of the polarizer 11. In the embodiment shown in FIG. 1C, the laminate protective film 13 (13′) including the transparent film layer 131 (131′) and the polyimide layer 132 (132′) is attached to each side of the polarizer 11 through the adhesive layer 12 (12′). In the embodiment shown in FIG. 1D, the laminate protective film 13 (13′) including the transparent film layer 131 (131′), the anchor coat layer 133 (133′), and the polyimide layer 132 (132′) is attached to each side of the polarizer 11 through the adhesive layer 12 (12′). The embodiments shown in FIGS. 1C and 1D each cause very little curling (warping) of a polarizing plate to be obtained due to its symmetrical structure. Further, the polyimide layer protects each side of the polarizer, to thereby provide a polarizing plate having excellent durability. Needless to say, the laminate protective film 13 including the transparent film layer 131 and the polyimide layer 132 may be attached to one side of the polarizer 11, and the laminate protective film 13′ including the transparent film layer 131′, the anchor coat layer 133′, and the polyimide layer 132′ may be attached to the opposite side of the polarizer 11. In a case where the laminate protective films 13 and 13′ are provided on both sides of the polarizer 11, materials forming the laminate protective films 13 and 13′ may be the same or different from each other.

In the present invention, if the laminate protective film 13 described above is provided on one side of the polarizer 11, any appropriate protective film 14 (protective film formed of a single transparent film, for example) may be provided on the opposite side of the polarizer 11. FIGS. 1E and 1F each illustrate an embodiment where a laminate protective film is provided on one side of the polarizer 11 and any appropriate protective film is provided on the opposite side thereof. In the embodiment shown in FIG. 1E, the laminate protective film 13 including the transparent film layer 131 and the polyimide layer 132 is attached to one side of the polarizer 11 through the adhesive layer 12, and any appropriate protective film 14 is attached to the opposite side of the polarizer 11 through the adhesive layer 12′. In the embodiment shown in FIG. 1F, the laminate protective film 13 including the transparent film layer 131, the anchor coat layer 133, and the polyimide layer 132 is attached to one side of the polarizer 11 through the adhesive layer 12, and any appropriate protective film 14 is attached to the opposite side of the polarizer 11 through the adhesive layer 12′. The embodiments shown in FIGS. 1E and 1F may each provide a polarizing plate having durability, productivity, and economical efficiency.

A total thickness of the polarizing plate of the present invention is preferably 25 μm to 700 μm, more preferably 30 μm to 500 μm, and most preferably 40 μm to 350 μm. A thickness of the polarizing plate within the above ranges can provide a thin polarizing plate having sufficient mechanical strength.

A light transmittance (a single axis transmittance) of the polarizing plate of the present invention is preferably 41% or more, and more preferably 43% or more measured by using light of a wavelength of 440 nm at 23° C. A theoretical upper limit of the single axis transmittance is 50%. A degree of polarization is preferably 99.90% to 100%, and more preferably 99.95% to 100%. A light transmittance and a degree of polarization within the above ranges can further enhance a contrast ratio in a normal direction of a liquid crystal display apparatus employing the polarizing plate of the present invention.

The single axis transmittance and the degree of polarization can be measured by using a spectrophotometer “DOT-3” (trade name, manufactured by Murakami Color Research Laboratory). The degree of polarization can be determined by: measuring a parallel light transmittance (H₀) and a perpendicular light transmittance (H₉₀); and using the following equation: Degree of polarization (%)={(H₀−H₉₀)/(H₀+H₉₀)}^{1/2}×100. The parallel light transmittance (H₀) can be determined by: piling two identical polarizers such that respective absorption axes are parallel to each other to produce a parallel laminate polarizer; and measuring a light transmittance of the parallel laminate polarizer. The perpendicular light transmittance (H₉₀) can be determined by: piling two identical polarizers such that respective absorption axes are perpendicular to each other to produce a perpendicular laminate polarizer; and measuring a light transmittance of the perpendicular laminate polarizer. The light transmittance refers to a Y value obtained through color correction by a two-degree field of view (C source) in accordance with JIS Z8701-1982.

As a hue of the polarizing plate of the present invention, a perpendicular Δab value is preferably 5.0 or less, and more preferably 4.0 or less. The perpendicular ab value can be measured by using a spectrophotometer “DOT-3” (trade name, manufactured by Murakami Color Research Laboratory). To be specific, the perpendicular Δab value can be determined by: piling two identical polarizers such that respective absorption axes are perpendicular to each other to produce a perpendicular laminate polarizer; measuring a perpendicular hue a value (a) and a perpendicular hue b value (b); and using the following equation: Δab=(a²+b²)^{1/2}. A perpendicular Δab value as close to 0 as possible minimizes coloring (to provide a darker black display and a brighter white display) in a normal direction of a liquid crystal display apparatus employing the polarizing plate of the present invention.

The polarizing plate of the present invention may have any appropriate moisture content. However, the polarizing plate has a moisture content of preferably 0.5% to 8.0%, more preferably 1.0% to 7.0%, and most preferably 2.0% to 6.5%.

A-2. Polarizer

In the specification of the present invention, the term “polarizer” refers to a film which may change natural light or polarized light to arbitrary polarized light. Any appropriate polarizer may be employed as a polarizer used for the polarizing plate of the present invention, but a film capable of changing natural light or polarized light to linearly polarized light is preferably used.

The polarizer 11 may have any appropriate thickness. The polarizer has a thickness of typically 5 μm to 80 μm, preferably 10 μm to 50 μm, and more preferably 20 μm to 40 μm.

The polarizer is formed of a stretched polymer film containing as a main component a polyvinyl alcohol-based resin, which contains a dichromatic substance, for example. The polymer film containing as a main component a polyvinyl alcohol-based resin is produced through a method described in [Example 1] of JP 2001-315144 A, for example.

The polyvinyl alcohol-based resin to be used may be prepared by: polymerizing a vinyl ester-based monomer to obtain a vinyl ester-based polymer; and saponifying the vinyl ester-polymer to convert a vinyl ester unit into a vinyl alcohol unit. Examples of the vinyl ester-based monomer include vinyl formate, vinyl acetate, vinyl propionate, vinyl valerate, vinyl laurate, vinyl stearate, vinylbenzoate, vinyl pivalate, and vinyl versatate. Of those, vinyl acetate is preferred.

The polyvinyl alcohol-based resin may have any appropriate average degree of polymerization. The average degree of polymerization is preferably 1,200 to 3,600, more preferably 1,600 to 3,200, and most preferably 1,800 to 3,000. The average degree of polymerization of the polyvinyl alcohol-based resin can be measured through a method in accordance with JIS K6726-1994.

A degree of saponification of the polyvinyl alcohol-based resin is preferably 90 mol % to 99.99 mol %, more preferably 95 mol % to 99.99 mol %, and most preferably 98 mol % to 99.99 mol % from a viewpoint of durability of the polarizer.

The degree of saponification refers to a ratio of units actually saponified into vinyl alcohol units to units which may be converted into vinyl alcohol units through saponification. The degree of saponification of the polyvinyl alcohol-based resin may be determined in accordance with JIS K6726-1994.

The polymer film containing as a main component a polyvinyl alcohol-based resin to be used in the present invention may preferably contain polyvalent alcohol as a plasticizer. Examples of the polyvalent alcohol include ethylene glycol, glycerin, propylene glycol, diethyleneglycol, triethyleneglycol, tetraethyleneglycol, and trimethylolpropane. The polyvalent alcohol may be used independently or in combination. In the present invention, ethylene glycol or glycerin is preferably used from the viewpoints of stretchability, transparency, thermal stability, and the like.

A use amount of the polyvalent alcohol in the present invention is preferably 1 to 30 (weight ratio), more preferably 3 to 25 (weight ratio), and most preferably 5 to 20 (weight ratio) with respect to 100 of a total solid content in the polyvinyl alcohol-based resin. A use amount of the polyvalent alcohol within the above ranges can provide a polymer film having excellent coloring property, stretchability, transparency, operability, and the like.

The polymer film containing as a main component a polyvinyl alcohol-based resin may further contain a surfactant. The surfactant is used for improving coloring property, stretchability, and the like.

Any appropriate type of surfactant may be employed, and specific examples thereof include an anionic surfactant, a cationic surfactant, and a nonionic surfactant. In the present invention, the nonionic surfactant is preferably used. Specific examples of the nonionic surfactant include lauric acid diethanolamide, coconut oil fatty acid diethanolamide, coconut oil fatty acid monoethanolamide, lauric acid monoisopropanolamide, and oleic acid monoisopropanolamide. In the present invention, lauric acid diethanolamide is preferably used.

A use amount of the surfactant is preferably 0.01 to 1 (weight ratio), more preferably 0.02 to 0.5 (weight ratio), and most preferably 0.05 to 0.3 (weight ratio) with respect to 100 of the total solid content in the polyvinyl alcohol-based resin. A use amount of the surfactant within the above ranges can further improve coloring property or stretchability.

Any appropriate dichromatic substance may be employed as the dichromatic substance. Specific examples thereof include iodine and a dichromaticdye. In the specification of the present invention, the term “dichromatic” refers to optical anisotropy in which light absorption differs in two directions of an optical axis direction and a direction perpendicular thereto.

Examples of the dichromatic dye include Red BR, Red LR, Red R, Pink LB, Rubin BL, Bordeaux GS, Sky Blue LG, Lemon Yellow, Blue BR, Blue 2R, Navy RY, Green LG, Violet LB, Violet B, Black H, Black B, Black GSP, Yellow 3G, Yellow R, Orange LR, Orange 3R, Scarlet GL, Scarlet KGL, Congo Red, Brilliant Violet BK, Supra Blue G, Supra Blue GL, Supra Orange GL, Direct Sky Blue, Direct Fast Orange S, and First Black.

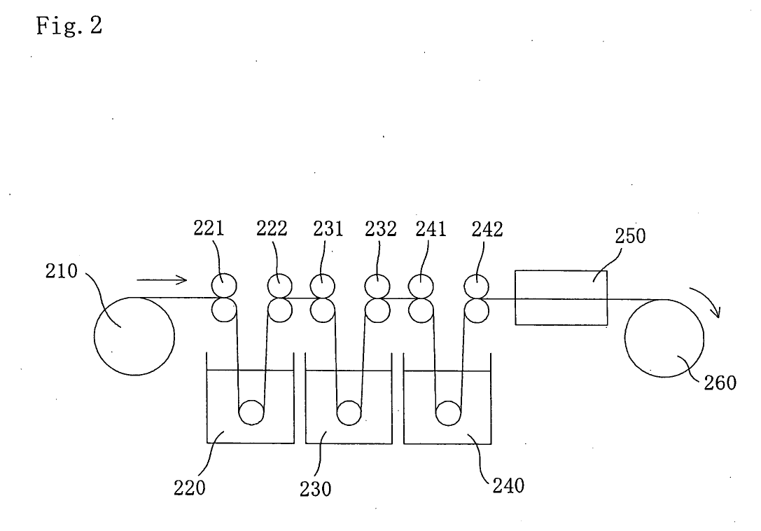

An example of a method of producing a polarizer will be described by referring to FIG. 2. FIG. 2 is a schematic diagram illustrating an overview of a typical production process of a polarizer used in the present invention. For example, a polymer film containing as a main component a polyvinyl alcohol-based resin is fed from a feed roller 210, immersed in an aqueous iodine solution bath 220, and subjected to swelling and coloring treatment under tension in a longitudinal direction of the film by rollers 221 and 222 at different speed ratios. Next, the film is immersed in a tank 230 of an aqueous solution containing boric acid and potassium iodide, and subjected to crosslinking treatment under tension in a longitudinal direction of the film by rollers 231 and 232 at different speed ratios. The film subjected to crosslinking treatment is immersed in a bath 240 of an aqueous solution containing potassium iodide by rollers 241 and 242, and subjected to water washing treatment. The film subjected to water washing treatment is dried by drying means 250 to adjust its moisture content, and taken up in a take-up part 260. The polymer film containing as a main component a polyvinyl alcohol-based resin may be stretched to a 5 to 7 times length of the original length through the above process.

The polarizer may have any appropriate moisture content, but the moisture content is preferably 5% to 40%, more preferably 10% to 30%, and most preferably 20% to 30%.

In addition to the above-described polarizer, further examples of the polarizer of the present invention include: a polarizer prepared by stretching a polymer film incorporating a dichromatic substance to be aligned in a specific direction; an O-type polarizer of a guest/host type prepared by aligning in a specific direction a liquid crystal composition containing a dichromatic substance and a liquid crystal compound (U.S. Pat. No. 5,523,863, JP 03-503322 A); and an E-type polarizer prepared by aligning lyotropic liquid crystals in a specific direction (U.S. Pat. No. 6,049,428).

In a case where polarizers are provided on both sides of a liquid crystal cell in the liquid crystal panel of the present invention described later, the polarizers may be the same or different from each other.

A-3 Laminate Protective Film

A-3-1. Transparent Film Layer

The transparent film layer 131 may be formed of any appropriate transparent film. The transparent film layer is preferably formed of a film having excellent transparency, mechanical strength, thermal stability, water barrier property, abrasion resistance, stability of retardation values, and the like. In the present invention, the transparent film layer may be formed of one layer or may have a laminate structure of two or more layers. In a case where the transparent film layer has a laminate structure, the layers may be formed of the same material or different materials. The transparent film layer (each layer in a case where the transparent film layer has a laminate structure) may be formed from a single resin or a blend of two or more types of resins.

The transparent film layer has a light transmittance of preferably 80% or more, more preferably 85% or more, and most preferably 90% or more measured by using light of a wavelength of 590 nm at 23° C.

The transparent film layer has a thickness of preferably 10 μm to 300 μm, more preferably 10 μm of 200 μm, and most preferably 10 μm to 100 μm.

The transparent film layer has Re[590] of preferably more than 0 nm and 350 nm or less, more preferably more than 0 nm and 150 nm or less, particularly preferably more than 0 nm and 100 nm or less, and most preferably more than 0 nm and 60 nm or less. In the specification of the present invention, Re[590] refers to an in-plane retardation value of the film measured by using light of a wavelength of 590 nm at 23° C. Re[590] can be determined from an equation Re[590]=(nx−ny)×d (wherein, nx and ny respectively represent refractive indices of the film in a slow axis direction and a fast axis direction at a wavelength of 590 nm, and d (nm) represents a thickness of the film). Note that, the slow axis refers to a direction providing a maximum in-plane refractive index of the film.

The transparent film layer has Rth[590] of preferably more than 0 nm and 400 nm or less, more preferably more than 0 nm and 350 nm or less, particularly preferably more than 0 nm and 200 nm or less, and most preferably more than 0 nm and 150 nm or less. In the specification of the present invention, Rth[590] refers to a thickness direction retardation value of the film measured by using light of a wavelength of 590 nm at 23° C. Rth[590] can be determined from an equation Rth[590]=(nx−nz)×d (wherein, nx and nz respectively represent refractive indices of the film in a slow axis direction and a thickness direction at a wavelength of 590 nm, and d (nm) represents a thickness of the film).

Re[590] and Rth[590] may be determined by using “KOBRA-21ADH” (trade name, manufactured by Oji Scientific Instruments). Refractive indices nx, ny, and nz can be determined by: using an in-plane retardation value (Re) of the film and a retardation value (R40) measured by tilting a slow axis by 40° as a tilt angle at a wavelength of 590 nm and 23° C., a thickness (d) of the retardation film, and an average refractive index (n0) of the retardation film; and using the following equations (A) to (F) for computational numerical calculation. Then, Rth can be calculated from the following equation (D). Here, Φ and ny′ are represented by the following respective equations (E) and (F).
Re=(nx−ny)×d (A)
R40=(nx−ny′)×d/cos(Φ) (B)
(nx+ny+nz)/3=n0 (C)
Rth=(nx−nz)×d (D)
Φ=sin⁻¹[sin(40°)/n0] (E)
ny′=ny×nz[ny²×sin²(Φ)+nz²×cos²(Φ)]^{1/2} (F)

An absolute value of photoelastic coefficient C[590] (m²/N) of the transparent film layer measured by using light of a wavelength of 590 nm at 23° C. is preferably 10×10⁻¹² to 8.0×10⁻¹¹, more preferably 1.0×10⁻¹² to 2.0×10⁻¹¹, and most preferably 1.0×10⁻¹² to 6.0×10⁻¹². An absolute value of photoelastic coefficient within the above ranges hardly causes shift or unevenness in retardation values of the transparent film layer due to shrinkage stress of the polarizer or heat of backlight, to thereby provide a liquid crystal display apparatus employing the transparent film layer having display properties with excellent optical uniformity.

Examples of a material forming the transparent film layer include a thermosetting resin, a UV-curable resin, a thermoplastic resin, a thermoplastic elastomer, and a biodegradable plastic. In the present invention, a polymer film containing as a main component a thermoplastic resin is preferably used in view of excellent operability, product quality, and economical efficiency. The thermoplastic resin may be a noncrystalline polymer or a crystalline polymer. The noncrystalline polymer has an advantage of exhibiting excellent transparency, and the crystalline polymer has advantages of exhibiting excellent rigidity, strength, and chemical resistance.

Any appropriate method may be employed as a method of obtaining the polymer film containing as a main component a thermoplastic resin. Examples thereof include: an extrusion method involving continues extrusion of a thermoplastic resin from a die for forming; a solvent casting method involving casting of a solution of a thermoplastic resin on a substrate and evaporation of a solvent for forming; and an inflation method involving extrusion of a thin thermoplastic resin tube from an extruder equipped with a cylindrical inflation die, and blowing of air into the tube while pinching an upper end of the tube by using a pinch roller to inflate the tube into a predetermined size for continuous forming of a cylindrical film.

Examples of the thermoplastic resin used for the transparent film layer include: general purpose plastics such as polyethylene, polypropylene, polynorbornene, polyvinyl chloride, cellulose acetate, polystyrene, an ABS resin, an AS resin, polymethylmethacrylate, polyvinyl acetate, and polyvinylidene chloride; general purpose engineering plastics such as polyamide, polyacetal, polycarbonate, modified polyphenylene ether, polybutylene terephthalate, and polyethylene terephthalate; and super engineering plastics such as polyphenylene sulfide, polysulfone, polyethersulfone, polyetheretherketone, polyarylate, a liquid crystalline polymer, polyamideimide, and polytetrafluoroethylene. The thermoplastic resin may be used independently or in combination. The thermoplastic resin may be used after any appropriate polymer modification. Examples of the polymer modification include copolymerization, branching, crosslinking, and modifications in molecular terminals and stereoregularity. In the present invention, a noncrystalline polymer of a thermoplastic resin having excellent transparency is preferably used.

Specific examples of the noncrystalline polymer of a thermoplastic resin include: a cellulose-based resin such as diacetyl cellulose or triacetyl cellulose; a polycarbonate-based resin, a norbornene-based resin, a polyolefin-based resin such as an ethylene/propylene copolymer; an amide-based resin such as nylon or aromatic polyamide; and an imide-based resin such as polyimide or polyimideamide. A polymer film containing as a main component a cellulose-based resin is preferably used as a film used for the transparent film layer.

Any appropriate cellulose-based resin may be employed as the cellulose-based resin. Specific examples thereof include organic acid esters such as cellulose acetate, cellulose propionate, and cellulose butyrate. The cellulose-based resin may be a mixed organic acid ester in which hydroxide groups of cellulose are substituted partly by an acetyl group and partly by a propionyl group, for example. The cellulose-based resin is produced, for example, through a method described in paragraphs [0040] and [0041] of JP 2001-188128 A.

The cellulose-based resin has a number average molecular weight (Mn) of preferably 70,000 to 300,000, and more preferably 90,000 to 200,000. A number average molecular weight of the cellulose-based resin within the above ranges can provide a transparent film having excellent thermal stability and mechanical strength.

In a case where a transparent film layer to be used in the present invention contains cellulose acetate, a degree of acetyl substitution is preferably 1.5 to 3.0, more preferably 2.0 to 3.0, and most preferably 2.4 to 2.9. In a case where a transparent film layer to be used in the present invention contains cellulose propionate, a degree of propionyl substitution is preferably 0.5 to 3.0, more preferably 0.5 to 2.0, and most preferably 0.5 to 1.5. In a case where a transparent film layer to be used in the present invention contains a mixed organic acid ester in which hydroxide groups of cellulose are substituted partly by an acetyl group and partly by a propionyl group, a total of degree of acetyl substitution and degree of propionyl substitution is preferably 1.5 to 3.0, more preferably 2.0 to 3.0, and particularly preferably 2.4 to 2.9. In this case, the degree of acetyl substitution is preferably 1.0 to 2.8 and more preferably 1.0 to 2.5; and the degree of propionyl substitution is preferably 0.2 to 2.0 and more preferably 0.5 to 2.0.

In the specification of the present invention, the degree of acetyl substitution (or degree of propionyl substitution) refers to the number of hydroxide groups, which are bonded to carbon atoms at 2, 3, and 6 positions in a cellulose repeating unit, substituted by acetyl groups (or propionyl groups). The acetyl groups (or propionyl groups) may unevenly substitute any carbon atoms at 2, 3, and 6 positions in a cellulose repeating unit, or may evenly substitute the carbon atoms at 2, 3, and 6 positions. The degree of acetyl substitution may be determined in accordance with ASTM-D817-91 (Standard Test Methods of Testing Cellulose Acetate Propionate and Cellulose Acetate Butyrate). The degree of propionyl substitution may be determined in accordance with ASTM-D817-96 (Standard Test Methods of Testing Cellulose Acetate Propionate and Cellulose Acetate Butyrate).

The transparent film layer may further contain any appropriate additive. Specific examples of the additive include a plasticizer, a thermal stabilizer, a light stabilizer, a lubricant, an antioxidant, a UV absorber, a flame retardant, a colorant, an antistatic agent, a compatibilizing agent, a crosslinking agent, and a thickener. The type and amount of the additive to be used may be appropriately set in accordance with the purpose. For example, a content of the additive is preferably 10 (weight ratio) or less, more preferably 5 (weight ratio) or less, and most preferably 3 (weight ratio) or less with respect to 100 of a total solid content in the polymer film.

In one embodiment of the present invention, a film used for the transparent film layer is a stretched film. For example, the transparent film layer may be formed of a stretched film of the polymer film containing as a main component the above-described thermoplastic resin. In the specification of the present invention, the term “stretched film” refers to a plastic film having enhanced orientation of molecules in a specific direction obtained by: applying tension to an unstretched film at an appropriate temperature; or applying tension to a film stretched in advance.

Any appropriate stretching method may be employed as a method of forming the stretched film. Specific examples of the stretching method include: a vertical uniaxial stretching method; a transverse uniaxial stretching method; a vertical and transverse simultaneous biaxial stretching method; and a vertical and transverse sequential biaxial stretching method. Any appropriate stretching machine such as a roll stretching machine, a tenter stretching machine, or a biaxial stretching machine may be used as stretching means. In a case where heat stretching is performed, a stretching temperature may be continuously changed or may be changed in steps. The stretching may be performed in two or more steps. The polymer film may be stretched in a longitudinal direction (machine direction (MD)) or width direction (transverse direction (TD)) of the film. Further, the stretching may be performed in an oblique direction (oblique stretching) through a stretching method described in FIG. 1 of JP 2003-262721 A.

In a case where the stretched film is used, the stretched film has Re[590] of preferably 10 nm to 350 nm, more preferably 20 nm to 150 nm, particularly preferably 30 to 100 nm, and most preferably 40 nm to 60 nm.

In a case where the stretched film is used, the stretched film has Rth[590] of preferably 20 nm to 400 nm, more preferably 25 nm to 350 nm, particularly preferably 30 nm to 200 nm, and most preferably 40 nm to 150 nm.

In another embodiment of the present invention, a film used for the transparent film layer is an isotropic film. In the specification of the present invention, the term “isotropic film” refers to a film having a small difference in optical properties in three-dimensional directions and having substantially no anisotropic optical properties such as birefringence. Note that the phrase “having substantially no anisotropic optical properties” indicates that isotropy includes a case where slight birefringence provides no adverse effects on display properties of a liquid crystal display apparatus in practical use.

In a case where the isotropic film is used, the isotropic film has Re[590] of preferably more than 0 nm and less than 10 nm, more preferably more than 0 nm and less than 5 nm, and most preferably more than 0 nm and less than 3 nm.

In a case where the isotropic film is used, the isotropic film has Rth[590] of preferably more than 0 nm and less than 20 nm, more preferably more than 0 nm and less than 10 nm, and most preferably more than 0 nm and less than 5 nm.

Any appropriate method may be employed as a method of obtaining the isotropic film. Specific examples thereof include an extrusion method, a solvent casting method, and an inflation method. The extrusion method is preferably used for forming an isotropic film.

A norbornene-based resin is preferably used as a material forming the isotropic film. An example of the norbornene-based resin is a norbornene polymer obtained by: subjecting a (co)polymer of a ring-opened norbornene-based monomer described in JP 06-51117 A to hydrogenation. The ring-opened norbornene-based monomer may be optionally subjected to modification such as maleic acid addition or cyclopentadiene addition. Another example thereof is a cycloolefin polymer obtained by polymerizing at least one of a polycyclic cycloolefin monomer such as norbornene described in JP 2002-348324 A, a monocyclic cycloolefin monomer, and an acyclic 1-olefin monomer in a solution state, suspension state, monomer molten state, or gas phase in the presence of a metallocene catalyst.

Further examples of the material forming the isotropic film include: a polycarbonate-based resin having 9,9-bis(4-hydroxyphenyl)fluorene on a side chain, described in JP 2001-253960 A; and a cellulose-based resin described in JP 07-112446 A. Still another example thereof is a polymer film described in JP 2001-343529 A such as a film formed from a resin composition containing: (A) a thermoplastic resin having a substituted and/or unsubstituted imide group on a side chain; and (B) a thermoplastic resin having a substituted and/or unsubstituted phenyl and nitrile groups on a side chain. A specific example of the resin composition is a resin composition containing: an alternating copolymer of isobutylene and N-methylmaleimide; and an acrylonitrile/styrene copolymer.

Further examples of the material forming the isotropic film include: a random copolymer of a monomer forming a polymer exhibiting positive birefringence and a monomer forming a polymer exhibiting negative birefringence, described in “Development and applied technology of optical polymer material” (p. 194 to p. 207, published by NTS Inc., 2003); and a polymer doped with an isotropic low molecular weight substances or birefringent crystals. However, the material forming the isotropic film is not limited to the above-described materials, and any appropriate material may be used as long as effects of the present invention can be obtained.

A-3-2. Anchor Coat Layer

Any appropriate material, which may improve adhesiveness between the transparent film layer 131 and the polyimide layer 132, may be used as a material forming the anchor coat layer 133. In addition, the material preferably has excellent transparency, thermal stability, low birefringence, and the like. An example of such a material is a thermoplastic resin containing as a main component polyester, polyacryl, polyurethane, polyvinylidene chloride, or the like.

The anchor coat layer may further contain any appropriate additive as required. Specific examples of the additive include a plasticizer, a thermal stabilizer, a light stabilizer, a lubricant, an antioxidant, a UV absorber, a flame retardant, a colorant, an antistatic agent, a compatibilizing agent, a crosslinking agent, and a thickener. The type and amount of the additive to be used may be appropriately set in accordance with the purpose. For example, a content of the additive is preferably 10 (weight ratio) or less, more preferably 5 (weight ratio) or less, and most preferably 3 (weight ratio) or less with respect to 100 of a total solid content in the anchor coat layer.

Of the thermoplastic resins, a thermoplastic resin containing as a main component polyester is preferably used as a material forming the anchor coat layer. The material forming the anchor coat layer to be used is more preferably a thermoplastic resin containing as a main component modified polyester obtained through copolymerization of polyurethane and polyester. Such modified polyester is produced through a method described in paragraphs [0025] to [0032] of JP 08-122969 A. A specific example of the modified polyester is “VYLON UR series” (trade name, organic solvent-based dispersion, available from Toyobo Co., Ltd.).

The anchor coat layer has a glass transition temperature (Tg) of preferably −20° C. to +20° C., more preferably −10° C. to +10° C., and particularly preferably −5° C. to +5° C. The glass transition temperature can be determined through a method in accordance with JIS K7121-1987 by differential scanning calorimetry (DSC) measurement.

The anchor coat layer may have any appropriate thickness. The anchor coat layer has a thickness of preferably 0.2 μm to 1.5 μm, more preferably 0.4 μm to 1.2 μm, and most preferably 0.7 μm to 1.0 μm. A thickness of the anchor coat layer within the above ranges can provide a polarizing plate having excellent durability causing no peeling or floating between the polyimide layer and the transparent film layer even when the polarizing plate of the present invention is exposed to high temperature and high humidity environment.

The anchor coat layer 133 is formed by: applying an application liquid containing the thermoplastic resin such as polyester in a predetermined ratio on a surface of the transparent film layer 131; and drying the whole. Any appropriate method may be employed as a method of preparing the application liquid. For example, a commercially available solution or dispersion may be used as the application liquid, or a solution prepared by adding a solvent to a commercially available solution or dispersion may be used as the application liquid. Alternatively, a solution prepared by dissolving or dispersing a solid content in various solvents may be used as the application liquid. Any appropriate method may be employed as a method of applying the application liquid, and an example thereof is an application method using a coater.

A total solid content in the application liquid may vary depending on the type, solubility, application viscosity, wettability, thickness after application of material forming the anchor coat layer, and the like. The total solid content is preferably 2 to 100 (weight ratio), more preferably 10 to 80 (weight ratio), and most preferably 20 to 60 (weight ratio) with respect to 100 of a solvent. A total solid content within the above ranges can provide an anchor coat layer having excellent surface evenness.

The application liquid may have any appropriate viscosity within a range allowing application. The viscosity is preferably 2 to 50 (mPa·s), more preferably 5 to 40 (mPa·s), and most preferably 10 to 30 (mPa·s) measured at 23° C. and a shear rate of 1,000 (1/s) A viscosity of the application liquid within the above ranges allows formation of an anchor coat layer having excellent surface evenness.

A-3-3. Polyimide Layer

The polyimide layer 132 may be obtained by applying a polyimide solution on a surface of the transparent film layer, and drying the whole, for example. The polyimide layer may further contain any appropriate additive as required. Specific examples of the additive include a plasticizer, a thermal stabilizer, a light stabilizer, a lubricant, an antioxidant, a UV absorber, a flame retardant, a colorant, an antistatic agent, a compatibilizing agent, a crosslinking agent, and a thickener. The type and amount of the additive to be used may be appropriately set in accordance with the purpose. For example, a content of the additive is preferably 10 (weight ratio) or less, more preferably 5 (weight ratio) or less, and most preferably 3 (weight ratio) or less with respect to 100 of a total solid content in a solution forming the polyimide layer.

Any appropriate polyimide may be employed as polyimide forming the polyimide layer 132. Specific examples thereof include aromatic polyimide, thermoplastic polyimide, thermosetting polyimide, fluorine-containing polyimide, photosensitive polyimide, alicyclic polyimide, liquid crystalline polyimide, and polysiloxane block polyimide. Polyimide may be used independently or in combination. Another example thereof is a resin composition prepared by blending polyimide, and polyamic acid which is a precursor of polyimide.

In the specification of the present invention, the term “aromatic polyimide” refers to polyimide having an aromatic structure in a molecule. A specific example of the aromatic polyimide is “KAPTON” (trade name, available from DuPont). The term “thermoplastic polyimide” refers to polyimide which softens under heating without a chemical reaction to exhibit plasticity and which solidifies under cooling. A specific example of the thermoplastic polyimide is “AURUM” (trade name, available from Mitsui Chemicals, Inc.). The term “thermosetting polyimide” refers to polyimide having a terminal functional group in a molecule. In the thermosetting polyimide, a terminal group of an oligomer having a weight average molecular weight of 1,000 to 7,000 crosslinks and cures by heat cleavage. A specific example of the thermosetting polyimide is “Kerimid 601” (trade name, available from Rhone-Poulenc SA). The term “fluorine-containing polyimide” refers to polyimide having a C—F bond such as a —CF₂— group or a —CF₃ group in a molecule. The term “photosensitive polyimide” refers to polyimide having a photoreactive group (such as a cinnamoyl group or a diazo group) causing a decomposition reaction or crosslinking reaction by light in molecule and which has different solubilies before and after the reaction. The term “alicyclic polyimide” refers to polyimide having an alicyclic structure in a molecule. The term “liquid crystalline polyimide” refers to polyimide exhibiting a liquid crystal phase by heating or addition of a solvent. The term “polysiloxane block polyimide” refers to polyimide having a polydimethylsiloxane structure in a molecular structure.

Polyimide may be typically obtained through a reaction between tetracarboxylic dianhydride and diamine. Any appropriate method may be employed as a method of reacting tetracarboxylic dianhydride and diamine. For example, the reaction may involve chemical imidation which proceeds in two steps or may involve heat imidation which proceeds in one step.

A specific example of the chemical imidation involves the following steps. In a first step, diamine is dissolved in a polar amide-based solvent such as dimethylacetamide or N-methylpyrrolidone. Tetracarboxylic dianhydride as a solid is added to the solution, and the whole is stirred at room temperature. Then, the solid tetracarboxylic dianhydride is dissolved and a ring opening polymerization addition reaction between tetracarboxylic dianhydride and diamine takes place with heat generation. Thus, a viscosity of a polymerization solution increases, and polyamic acid is produced. In a second step, a dehydrating agent such as acetic anhydride is added to the reaction solution containing polyamic acid, and the whole is heated. Thus, a dehydration ring formation reaction takes place, and polyimide is produced.

A specific example of the heat imidation involves the following. In a reaction vessel equipped with a Dean-Stark device, diamine, tetracarboxylic dianhydride, and isoquinoline (catalyst) are dissolved in a high boiling point organic solvent such as m-cresol. The solution is stirred and heated at 175 to 180° C. Thus, a dehydration ring formation reaction takes place, and polyimide is produced.

Examples of tetracarboxylic dianhydride to be used in the present invention include pyromellitic dianhydride, benzophenonetetracarboxylic dianhydride, naphthalenetetracarboxylic dianhydride, heterocyclic aromatic tetracarboxylic dianhydride, and 2,2′-substituted biphenyltetracarboxylic dianhydride.

Examples of pyromellitic dianhydride include: pyromellitic dianhydride; 3,6-diphenylpyromellitic dianhydride; 3,6-bis(trifluoromethyl)pyromellitic dianhydride; 3,6-dibromopyromellitic dianhydride; and 3,6-dichloropyromellitic dianhydride. Examples of benzophenonetetracarboxylic dianhydride include: 3,3′,4,4′-benzophenonetetracarboxylic dianhydride; 2,3,3′,4′-benzophenonetetracarboxylic dianhydride; and 2,2′,3,3′-benzophenonetetracarboxylic dianhydride. Examples of naphthalenetetracarboxylic dianhydride include: 2,3,6,7-naphthalene-tetracarboxylic dianhydride; 1,2,5,6-naphthalene-tetracarboxylic dianhydride; and 2,6-dichloro-naphthalene-1,4,5,8-tetracarboxylic dianhydride.

Examples of heterocyclic aromatic tetracarboxylic dianhydride include: thiophene-2,3,4,5-tetracarboxylic dianhydride; pyrazine-2,3,5,6-tetracarboxylic dianhydride; and pyridine-2,3,5,6-tetracarboxylic dianhydride. Examples of 2,2′-substituted biphenyltetracarboxylic anhydride include: 2,2′-dibromo-4,4′,5,5′-biphenyltetracarboxylic dianhydride; 2,2′-dichloro-4,4′,5,5′-biphenyltetracarboxylic dianhydride; and 2,2′-bis(trifluoromethyl)-4,4′,5,5′-biphenyltetracarboxylic dianhydride.

Other examples of aromatic tetracarboxylic dianhydride include: 3,3′,4,4′-biphenyltetracarboxylic dianhydride; bis(2,3-dicarboxyphenyl)methane dianhydride; bis(2,5,6-trifluoro-3,4-dicarboxyphenyl)methane dianhydride; 2,2′-bis(3,4-dicarboxyphenyl)-hexafluoropropane dianhydride; 4,4′-bis(3,4-dicarboxyphenyl)-2,2-diphenylpropane dianhydride; bis(3,4-dicarboxyphenyl)ether dianhydride; 4,4′-oxydiphthalic dianhydride; bis(3,4-dicarboxyphenyl)sulfonic dianhydride; 3,3′,4,4′-diphenylsulfonetetracarboxylic dianhydride; 4,4′-[4,4′-isopropylidene-di(p-phenyleneoxy)]bis(phthalic anhydride); N,N-(3,4-dicarboxyphenyl)-N-methylamine dianhydride; and bis (3,4-dicarboxyphenyl)diethylsilane dianhydride. Of those, 2,2′-substituted biphenyltetracarboxylic dianhydride is preferred in the present invention. 2,2′-bis(trihalomethyl)-4,4′,5,5′-biphenyltetracarboxylic dianhydride is more preferred, and 2,2′-bis(3,4-dicarboxyphenyl)-hexafluoropropane dianhydride is particularly preferred.

Diamine to be used in the present invention is not particularly limited, and examples thereof include benzenediamine, diaminobenzophenone, naphthalenediamine, heterocyclic aromatic diamine, and other aromatic diamines.

Examples of benzenediamine include: o-, m-, and p-phenylenediamines; 2,4-diaminotoluene; 1,4-diamino-2-methoxybenzene; 1,4-diamino-2-phenylbenzene; and 1,3-diamino-4-chlorobenzene. Examples of diaminobenzophenone include: 2,2′-diaminobenzophenone; and 3,3′-diaminobenzophenone. Examples of naphthalenediamine include: 1,8-diaminonaphthalene; and 1,5-diaminonaphthalene. Examples of heterocyclic aromatic diamine include: 2,6-diaminopyridine; 2,4-diaminopyridine; and 2,4-diamino-S-triazine.

Other examples of diamine include: 4,4′-diaminobiphenyl; 4,4′-diaminodiphenylmethane; 4,4′-(9-fluorenylidene)-dianiline; 2,2′-bis(trifluoromethyl)-4,4′-diaminobiphenyl; 3,3′-dichloro-4,4′-diaminodiphenylmethane; 2,2′-dichloro-4,4′-diaminobiphenyl; 2,2′,5,5′-tetrachlorobenzidine; 2,2-bis(4-aminophenoxyphenyl)propane; 2,2-bis(4-aminophenyl)propane; 2,2-bis(4-aminophenyl)-1,1,1,3,3,3-hexafluoropropane; 4,4′-diaminodiphenyl ether; 3,4′-diaminodiphenyl ether; 1,3-bis(3-aminophenoxy)benzene; 1,3-bis(4-aminophenoxy)benzene; 1,4-bis(4-aminophenoxy)benzene; 4,4′-bis(4-aminophenoxy)biphenyl; 4,4′-bis(3-aminophenoxy)biphenyl; 2,2-bis[4-(4-aminophenoxy)phenyl]propane; 2,2-bis[4-(4-aminophenoxy)phenyl]-1,1,1,3,3,3-hexafluoropropane; 4,4′-diaminodiphenyl thioether; and 4,4′-diaminodiphenyl sulfone. Of those, 2,2-bis (trifluoromethyl)-4,4′-diaminobiphenyl is preferred in the present invention.

At least one polyimide obtained through a reaction between tetracarboxylic dianhydride and diamine may be appropriately selected and used as polyimide used in the present invention. However, polyimide is not limited thereto, and any appropriate polyimide may be employed as long as the effects of the present invention can be obtained. Polyimide to be used preferably has excellent transparency, solubility, mechanical strength, thermal stability, water barrier property, stability of retardation values, and the like. In the present invention, fluorine-containing polyimide having a C—F bond in a molecule is preferably used for particularly excellent transparency and solubility. A specific example of fluorine-containing polyimide is polyimide disclosed in “New polyimide” (p. 274 to p. 275, edited by Nihon Polyimide Kenkyukai, 2002). Another example thereof is polyimide containing a repeating unit represented by the below-indicated formula (1), obtained by using: 2,2′-bis(3,4-dicarboxyphenyl)-hexafluoropropane dianhydride as tetracarboxylic dianhydride; and 2,2-bis(trifluoromethyl)-4,4′-diaminobiphenyl as diamine.

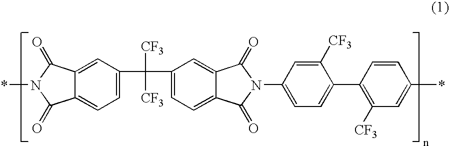

A weight average molecular weight (Mw) of polyimide to be used in the present invention is determined by using as a developing solvent a dimethylformamide solution (1 L of a dimethylformamide solution prepared by: adding 10 mM lithium bromide and 10 mM phosphoric acid; and filling up a 1 L volumetric flask). Polyimide to be used in the present invention has a weight average molecular weight (Mw) of preferably 20,000 to 180,000, more preferably 50,000 to 150,000, and most preferably 70,000 to 130,000 in polyethylene oxide equivalent. A weight average molecular weight of polyimide within the above ranges can provide a polyimide layer having excellent mechanical strength. Further, a weight average molecular weight thereof within the above ranges can provide an effect of inhibiting change in optical properties of the polarizing plate of the present invention even if it is exposed to high temperature and high humidity environment.

Any appropriate imidation rate may be employed as an imidation rate of polyimide to be used in the present invention. The imidation rate is preferably 90% or more, more preferably 95% or more, and most preferably 98% or more. The imidation rate can be determined from a nuclear magnetic resonance (NMR) spectrum by using an integrated intensity ratio of a peak of proton derived from polyamic acid, which is a precursor of polyimide, and a peak of proton derived from polyimide.

The polyimide layer has a thickness of preferably 1 μm to 10 μm, more preferably 1 μm to 8 μm, particularly preferably 1 μm to 6 μm, and most preferably 1 μm to 5 μm. A very thin polyimide layer is attached to a polarizer through a specific adhesive layer (described below), to thereby significantly improve adhesiveness between the polyimide layer and the polarizer. As a result, even if the polyimide layer is laminated on the polarizer, a polarizing plate causing no peeling or floating across an entire surface can be obtained. In general, polyimide has a large absolute value of photoelastic coefficient. Thus, a case where a polyimide layer is laminated on a polarizer and the whole is used for a liquid crystal display appratus may involve a problem of causing shift or unevenness in retardation values due to shrinkage stress of the polarizer or heat of backlight. However, the polyimide layer to be used in the present invention is a thin layer and has large retardation values, to thereby provide display properties with excellent optical uniformity.

An amount of a residual volatile component in the polyimide layer is not particularly limited, but is preferably more than 0% and 5% or less, and more preferably more than 0% and 3% or less. An amount of the residual volatile component within the above ranges can provide a polyimide layer having excellent stability in retardation values. The amount of the residual volatile component in the polyimide layer may be determined from reduction in weight of the polyimide layer before and after heating at 250° C. for 10 min.

The polyimide layer has a light transmittance of preferably 80% or more, more preferably 85% or more, and most preferably 90% or more measured by using light of a wavelength of 590 nm at 23° C. In general, polyimide is liable to be colored yellow or brown, and a polyimide layer having a thickness of more than 1 μm hardly has a high light transmittance. However, in the present invention, polyimide having a bulky atom or substituent in a molecular structure (such as polyimide containing a fluorine atom (C—F bond, for example)) is used, to thereby realize a desired thickness direction retardation value at a very large thickness and provide a polyimide layer having a very high light transmittance.

During solvent evaporation in application of a polyimide solution on a surface of a transparent film and drying of the whole, polyimide molecules align spontaneously by property of polyimide itself, and thus the polyimide layer may be used as a negative C plate. In the specification of the present invention, the term “negative C plate” refers to a plate (also referred to as a negative uniaxial retardation film having an optical axis in a thickness direction) satisfying a refractive index profile of nx≈ny>nz (wherein, nx and ny represent main in-plane refractive indices of the film and nz represents a refractive index in a thickness direction) The negative C plate needs not have a relationship strictly limited to nx=ny, and the negative C plate includes a plate having a small in-plane birefringence of the film without adversely affecting display properties of a liquid crystal display apparatus in practical use. To be specific, the polyimide layer has Re[590] of preferably 0 nm to 10 nm, more preferably 0 nm to 5 nm, and most preferably 0 nm to 3 nm.

The polyimide layer which may also serve as the negative C plate has Rth[590] of preferably 50 nm to 800 nm, more preferably 80 nm to 400 nm, and most preferably 100 nm to 300 nm. Rth of the polyimide layer within the above ranges allows optical compensation of a thickness direction retardation value of a liquid crystal cell of VA mode or OCB mode by a single polyimide layer, to thereby contribute to reduction in thickness of a liquid crystal panel. Rth[590] of the polyimide layer may be optimized in accordance with alignment mode of a liquid crystal display apparatus, and the type of other retardation plates to be used in the liquid crystal display apparatus. Rth[590] of the polyimide layer may be appropriately adjusted by changing the thickness of the polyimide layer.

The polyimide layer which may also serve as the negative C plate has a thickness direction birefringence (Δn[xz]) of preferably 0.005 to 0.15, more preferably 0.01 to 0.08, and most preferably 0.02 to 0.06. Δn[xz] of the polyimide layer may be adjusted by appropriately selecting the type of polyimide to be used. To be specific, polyimide with a rigid molecular structure is selected for a large Δn[xz], and polyimide with a flexible molecular structure is selected for a small Δn[xz].

The polyimide layer may be used as a biaxial retardation film having enhanced molecular orientation in a stretching direction by: applying a polyimide solution; drying the whole; and stretching the resultant to apply tension in an in-plane direction of the film. In the specification of the present invention, the term “biaxial retardation film” refers to a film having a refractive index profile of nx>ny>nz (wherein, nx and ny represent main in-plane refractive indices of the film and nz represents a refractive index in a thickness direction). A film satisfying the relationship of nx>ny>nz may be reworded as a film satisfying an expression of Rth[590]>Re[590] The polyimide layer is stretched as a laminate film with a transparent film layer, and thus tension may be applied in a width direction uniformly even though the polyimide layer is very thin. The above-describe method can provide a polyimide layer having excellent evenness in retardation values and thickness.

Any appropriate method may be employed as a stretching method. Specific examples thereof include: a vertical uniaxial stretching method; a transverse uniaxial stretching method; a vertical and transverse simultaneous biaxial stretching method; and a vertical and transverse sequential biaxial stretching method. Any appropriate stretching machine such as a roll stretching machine, a tenter, or a biaxial stretching machine may be employed as stretching means. In a case where heat stretching is performed, a stretching temperature may be continuously changed or may be changed in steps. The stretching may be performed in two or more steps. The polymer film may be stretched in a longitudinal direction (machine direction (MD)) or width direction (transverse direction (TD)) of the film. Further, the stretching may be performed in an oblique direction (oblique stretching) through a stretching method described in FIG. 1 of JP 2003-262721 A.

The polyimide which may also serve as the biaxial retardation film has Re[590] of preferably 10 nm to 350 nm, more preferably 30 nm to 200 nm, and most preferably 40 nm to 100 nm. Re[590] of the polyimide layer may be optimized in accordance with alignment mode of a liquid crystal display apparatus, and the type of other retardation plates to be used in the liquid crystal display apparatus. Re[590] of the polyimide layer may be appropriately adjusted by changing the thickness of the polyimide layer, a stretching temperature, a stretch ratio, and the like.

The polyimide layer which may also serve as the biaxial retardation film has an in-plane birefringence of the film (Δn[xy]) of preferably 0.00050 to 0.10, more preferably 0.0010 to 0.0050, and most preferably 0.0015 to 0.035. Δn[xy] of the polyimide layer may be optimized in accordance with alignment mode of a liquid crystal display apparatus, and the type of other retardation plates to be used in the liquid crystal display apparatus. Δn[xy] of the polyimide layer may be appropriately adjusted by changing the thickness of the polyimide layer, a stretching temperature, a stretch ratio, and the like.

Variation in direction (alignment angle) of a slow axis of the polyimide layer which may also serve as the biaxial retardation film is preferably as small as possible, to thereby provide a high contrast ratio in a normal direction of a liquid crystal display apparatus. A range of variation in alignment angle among five points of measurement provided at equal intervals in a width direction of the film is preferably ±2.0° to ±1.0°, more preferably ±1.0° to ±0.5°, and most preferably ±0.5° or less. Not that, the alignment angle can be determined by using “KOBRA-21ADH” (trade name, manufactured by Oji Scientific Instruments), for example.

The polyimide layer which may also serve as the biaxial retardation film has Rth[590] of preferably 50 nm to 900 nm, more preferably 80 nm to 500 nm, and most preferably 100 nm to 400 nm. Rth[590] of the polyimide layer may be optimized in accordance with alignment mode of a liquid crystal display apparatus, and the type of other retardation plates to be used in the liquid crystal display apparatus. Rth[590] of the polyimide layer may be appropriately adjusted by changing the thickness of the polyimide layer, a stretching temperature, a stretch ratio, and the like.

The polyimide layer which may also serve as the biaxial retardation film has a thickness direction birefringence (Δn[xz]) of preferably 0.007 to 0.23, more preferably 0.015 to 0.12, and most preferably 0.03 to 0.09. Δn[xz] of the polyimide layer may be optimized in accordance with alignment mode of a liquid crystal display apparatus, and the type of other retardation plates to be used in the liquid crystal display apparatus. Δn[xz] of the polyimide layer may be appropriately adjusted by changing the thickness of the polyimide layer, a stretching temperature, a stretch ratio, and the like.

In a case where the polyimide layer is used as the biaxial retardation film, a relationship between an absorption axis of a polarizer and a slow axis of the polyimide layer is not particularly limited. However, the absorption axis of the polarizer and the slow axis of the polyimide layer are preferably parallel, perpendicular, or at 45° to each other. In a case where the absorption axis of the polarizer and the slow axis of the polyimide layer are arranged parallel to each other, an angle formed between the absorption axis of the polarizer and the slow axis of the polyimide layer is preferably 0°±1.0°, more preferably 0°±0.5°, and most preferably 0°±0.3°. In a case where the absorption axis of the polarizer and the slow axis of the polyimide layer are arranged perpendicular to each other, an angle formed between the absorption axis of the polarizer and the slow axis of the polyimide layer is preferably 90°±1.0°, more preferably 90°±0.5°, and most preferably 90°±0.3°. In a case where the absorption axis of the polarizer and the slow axis of the polyimide layer are arranged at 45° to each other, an angle formed between the absorption axis of the polarizer and the slow axis of the polyimide layer is preferably 45°±1.0°, more preferably 45°±0.5°, and most preferably 45°±0.3°.

A-3-4. Overall Structure of Laminate Protective Film

As described above, the laminate protective film 13 only needs to include the polyimide layer 132 on one side of the transparent film layer 131. As shown in FIG. 1A, the transparent film layer 131 and the polyimide layer 132 may be directly laminated, or as shown in FIG. 1B, the transparent film layer 131 and the polyimide layer 132 may be laminated through the anchor coat layer 133.

A total thickness of the laminate protective film 13 is preferably 10 μm to 200 μm, more preferably 20 μm to 160 μm, and most preferably 30 μm to 110 μm. A total thickness of the laminate protective film 13 within the above ranges can provide sufficient mechanical strength.

A light transmittance of the laminate protective film measured by using light of a wavelength of 590 nm at 23° C. is preferably 80% or more, more preferably 85% or more, and most preferably 90% or more.

Re[590] of the laminate protective film is preferably more than 0 nm and 700 nm or less, more preferably more than 0 nm and 350 nm or less, and most preferably more than 0 nm and 200 nm or less. Re[590] of the laminate protective film within the above ranges can further enhance a contrast ratio in an oblique direction of a liquid crystal display apparatus employing the laminate protective film.

Rth[590] of the laminate protective film is preferably 50 nm to 1,100 nm, more preferably 80 nm to 650 nm, and most preferably 100 nm to 480 nm. Rth[590] of the laminate protective film within the above ranges can further enhance a contrast ratio in an oblique direction of a liquid crystal display apparatus employing the laminate protective film.

A-4. Adhesive Layer

The adhesive layer 12 is formed by, for example: applying an application liquid containing an adhesive in a predetermined ratio on a surface of the laminate protective film 13 (actually, polyimide layer 132) and/or a surface of the polarizer 11; and drying the whole. Any appropriate method may be employed as a method of preparing the application liquid. For example, a commercially available solution or dispersion may be used as the application liquid, or a solution or dispersion prepared by adding a solvent to a commercially available solution or dispersion may be used as the application liquid. Alternatively, a solution or dispersion prepared by dissolving or dispersing a solid content in various solvents may be used as application liquid.

An adhesive having any appropriate property, form, and adhesive mechanism may be used in accordance with the purpose. Specific examples of the adhesive include a water-soluble adhesive, a solvent-type adhesive, an emulsion-type adhesive, a latex-type adhesive, a mastic adhesive, a multilayer adhesive, a paste adhesive, a foam-type adhesive, and a supported film adhesive. Further specific examples of the adhesive include a thermoplastic-type adhesive, a heat melt-type adhesive, a heat solidification-type adhesive, a hot melt adhesive, a heat active adhesive, a heat sealing adhesive, a heat-curable adhesive, a contact-type adhesive, a pressure sensitive adhesive, a polymerization-type adhesive, and a solvent active adhesive. Of those, a water-soluble adhesive having excellent transparency, adhesiveness, operability, product quality, and economical efficiency is preferably used in the present invention.

The water-soluble adhesive contains as a main component a water-soluble natural polymer and/or a water-soluble synthetic polymer. Specific examples of the natural polymer include protein and starch. Specific examples of the synthetic polymer include a resole resin, a urea resin, a melamine resin, polyvinyl alcohol, polyethylene oxide, polyacrylamide, polyvinyl pyrrolidone, acrylate, and methacrylate.

Of the water-soluble adhesives, an adhesive containing as a main component a polyvinyl alcohol-based resin is preferably used in the present invention, and an adhesive containing as a main component modified polyvinyl alcohol having an acetoacetyl group is more preferably used because of extremely excellent adhesiveness to the polarizer and extremely excellent adhesiveness to the polyimide layer. Specific examples of modified polyvinyl alcohol having an acetoacetyl group include: “GOHSEFIMER Z series” (trade name, available from Nippon Synthetic Chemical Industry Co., Ltd.); and “GOHSENOL NH series” (tradename, available from Nippon Synthetic Chemical Industry Co., Ltd.).

The water-soluble adhesive containing as a main component a polyvinyl alcohol-based resin may preferably further contain a crosslinking agent to further improve water resistance. Examples of the crosslinking agent include an amine compound, an aldehyde compound, a methylol compound, an epoxy compound, an isocyanate compound, and a polyvalent metal salt. Of those, an amine compound, an aldehyde compound, and a methylol compound are preferably used in the present invention. Specific examples of the aldehyde compound include: “Glyoxal” (trade name, available from Nippon Synthetic Chemical Industry Co., Ltd.); and “Sequarez 755” (trade name, available from OMNOVA Solutions Inc.). A specific example of the amine compound is “m-Xylylenediamine” (trade name, available from Mitsubishi Gas Chemical Company, Inc.). A specific example of the methylol compound is “WATERSOL series” (trade name, available from Dainippon Ink and Chemicals, Incorporated).

A mixing amount of the crosslinking agent is preferably 5 to 35 parts by weight, more preferably 5 to 30 parts by weight, and most preferably 7 to 20 parts by weight with respect to 100 parts by weight of polyvinyl alcohol (preferably modified polyvinyl alcohol having an acetoacetyl group). A mixing amount of the crosslinking agent within the above ranges allows formation of an adhesive layer having excellent transparency, adhesiveness, and water resistance.

A total solid content in the adhesive may vary depending on the solubility, application viscosity, wettability, intended thickness, and the like of the adhesive. The total solid content is preferably 1 to 30 (weight ratio), more preferably 2 to 25 (weight ratio), and most preferably 2 to 20 (weight ratio) with respect to 100 of a solvent. A total solid content in the adhesive within the above ranges can provide an adhesive layer having a highly even surface.

A viscosity of the adhesive is not particularly limited, but is preferably 2 to 50 (mPa·s), more preferably 2 to 30 (mPa·s), and most preferably 4 to 20 (mPa·s) measured at 23° C. and a shear rate of 1,000 (1/s). A viscosity of the adhesive within the above ranges allows formation of an adhesive layer having excellent surface evenness.

Any appropriate method may be employed as a method of applying the application liquid, and an example thereof includes an application method using a coater. A coater to be used may be appropriately selected from the coaters in the section A-5-1 described below.

A glass transition temperature (Tg) of the adhesive is not particularly limited, but is preferably 20° C. to 120° C., more preferably 40° C. to 100° C., and most preferably 50° C. to 90° C. The glass transition temperature can be determined through a method in accordance with JIS K7121-1987 by differential scanning calorimetry (DSC) measurement.

A thickness of the adhesive layer is not particularly limited, but is preferably 0.01 μm to 0.15 μm, more preferably 0.02 μm to 0.12 μm, and most preferably 0.03 μm to 0.09 μm. A thickness of the adhesive layer within the above ranges can provide a polarizing plate having excellent durability causing no peeling or floating of the polarizer even when the polarizing plate of the present invention is exposed to high temperature and high humidity environment.

A-5. Method of Producing Polarizing Plate

A method of producing a polarizing plate of the present invention includes the steps of: applying a polyimide solution or dispersion on a surface of the transparent film and drying the whole, so as to obtain a laminate film including a transparent film layer and a polyimide layer; and attaching the laminate film and a polarizer together through an adhesive such that the polyimide layer opposes the polarizer. The method of producing a polarizing plate of the present invention preferably further includes the step of subjecting the surface of the polyimide layer to modification treatment after the step of applying a polyimide solution on a surface of a transparent film and drying the whole to obtain the laminate film (and before the step of attaching the laminate film and the polarizer together) Surface modification treatment can enhance wettability of the adhesive to the polyimide layer, to thereby improve adhesiveness between the polyimide layer and the adhesive layer. Hereinafter, a preferred example of an overview of the method of producing a polarizing plate of the present invention will be described by referring to drawings, and then details of each step will be described.

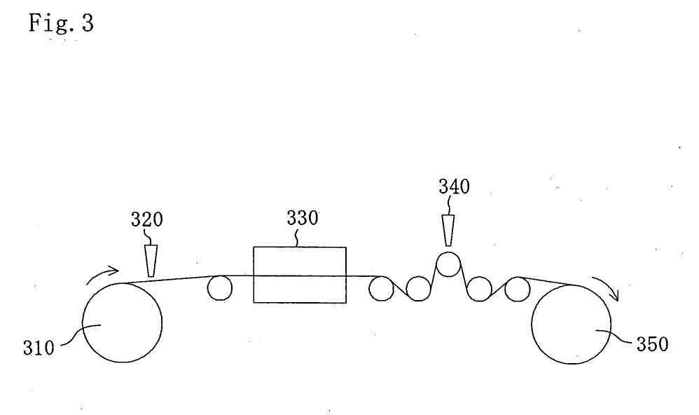

FIG. 3 is a schematic diagram illustrating an overview of the step of applying a polyimide solution (section A-5-1 described below) and the step of surface modification treatment (section A-5-2 described below). FIG. 3 shows a case where the surface modification treatment involves a dry process such as corona treatment and ozone treatment. A transparent film is fed from a feed part 310, and a polyimide solution is applied on a surface of the transparent film in a coater part 320. The transparent film having the polyimide solution applied thereon is fed to dry means 330 where a solvent is evaporated, to thereby form a laminate film including a polyimide layer and a transparent film layer. Next, the laminate film is fed to a surface modification treatment part 340 where the laminate film is subjected to modification treatment of a surface of the polyimide layer. The laminate film is taken up by a take-up part 350, and is subjected to the step of attaching the laminate film and the polarizer together. In a case where surface modification of the polyimide layer is not performed, or where a wet process described below is performed, the step of surface modification treatment performed in the surface modification treatment part 340 may be omitted. Alternatively, the wet process described below may be further performed after the dry process is performed. The dry process and the wet process may be combined, to thereby further enhance adhesiveness between the polarizer and the polyimide layer of the laminate film.

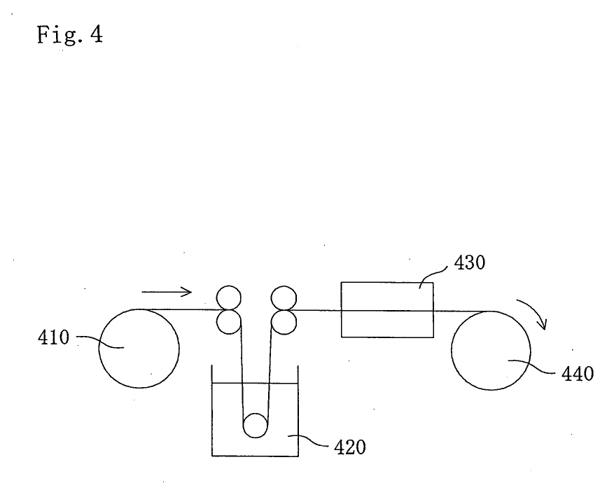

FIG. 4 shows a case where the surface modification treatment involves a wet process such as an alkali process. The laminate film obtained through the steps shown in FIG. 3 (however, surface modification treatment may be omitted) is fed from a feed part 410, and is passed through a treatment liquid bath 420. Next, the laminate film is fed to dry means 430 where the treatment liquid is removed. Finally, the laminate film is taken up by a take-up part 440, and is subjected to the step of attaching the laminate film and the polarizer together. Needless to say, the step of applying a polyimide solution and the step of wet surface modification treatment may be performed continuously.

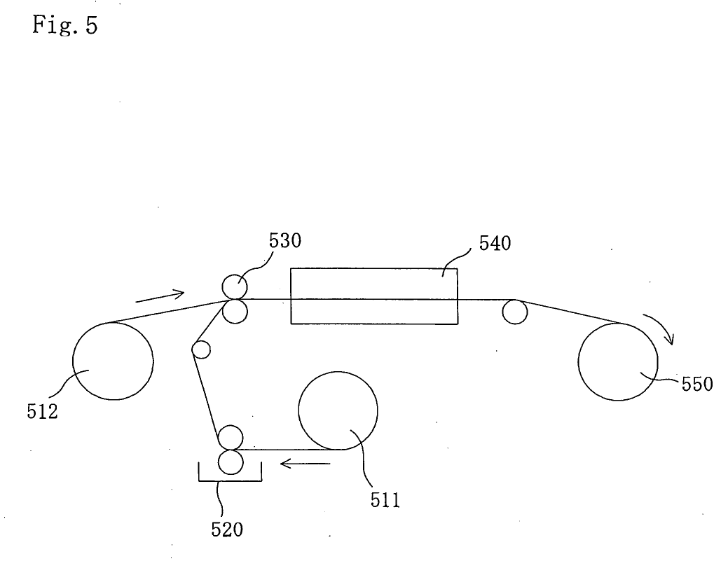

FIG. 5 is a schematic diagram illustrating an overview of the step of attaching a laminate film and a polarizer together (section A-5-3 described below). A laminate film is fed from a first feed part 511, and an adhesive is applied on a surface of a polyimide layer in a coater part 520. Meanwhile, a polarizer is fed from a second feed part 512. The laminate film having the adhesive applied thereon and the polarizer are attached together by an attaching roller 530. The whole is fed to dry means 540 where the adhesive is dried, to thereby form an adhesive layer. In this way, a polarizing plate is produced. The obtained polarizing plate is taken up in a take-up part 550.

Hereinafter, each step in the production method of the present invention will be described in detail.

A-5-1. Method of Applying Polyimide Solution

Any appropriate polyimide solution may be employed as a polyimide solution to be used for the production method of the present invention as long as the effects of the present invention can be obtained. A solution prepared by dissolving powder or pellets of polyimide in a solvent may be used as the polyimide solution, or a reaction solution obtained through polyimide synthesis may be used as the polyimide solution as it is. In the present invention, a solution prepared by dissolving polyimide powder in a solvent is preferably used to provide a polyimide layer having little optical defects such as flaws and bright points.

A total solid content in the polyimide solution may vary depending on the type, solubility, application viscosity, wettability, intended thickness, and the like of polyimide to be used. The total solid content in the polyimide solution is preferably 2 to 100 (weight ratio), more preferably 10 to 50 (weight ratio), and most preferably 10 to 40 (weight ratio) with respect to 100 of a solvent. A total solid content in the polyimide solution within the above ranges allows formation of a very thin polyimide layer having excellent surface evenness and optical uniformity.

Any appropriate liquid substance capable of uniformly dissolving polyimide and forming a solution may be employed as the solvent. Examples of the solvent include: a nonpolar solvent such as benzene or hexane; and a polar solvent such as water or alcohol. Further examples of the solvent include: an inorganic solvent such as water; and an organic solvent such as alcohols, ketones, ethers, esters, aliphatic and aromatic hydrocarbons, halogenated hydrocarbons, amides, and cellosolves.

Specific examples of alcohols used as the solvent include: n-butanol; 2-butanol; cyclohexanol; isopropyl alcohol; t-butyl alcohol; glycerine; ethylene glycol; 2-methyl-2,4-pentanediol; phenol; and parachlorophenol. Specific examples of ketones used as the solvent include acetone, methyl ethyl ketone, methyl isobutyl ketone, cyclohexanone, cyclopentanone, 2-pentanone, 2-hexanone, and 2-heptanone. Specific examples of ethers used as the solvent include diethyl ether, tetrahydrofuran, dioxane, and anisole. Specific examples of esters used as the solvent include ethyl acetate, butyl acetate, and methyl lactate. Specific examples of aliphatic and aromatic hydrocarbons used as the solvent include n-hexane, benzene, toluene, and xylene. Specific examples of halogenated hydrocarbons used as the solvent include chloroform, dichloromethane, carbon tetrachloride, dichloroethane, trichloroethane, trichloroethylene, tetrachloroethylene, and chlorobenzene. Specific examples of amides used as the solvent include dimethylformamide and dimethylacetamide. Specific examples of cellosolves used as the solvent include methyl cellosolve, ethyl cellosolve, and methyl cellosolve acetate. The solvent may be used independently or in combination. The above-described solvents are mere examples, and the solvent used in the present invention is not limited thereto.

Examples of a particularly preferred solvent include cyclopentanone, cyclohexanone, methyl isobutyl ketone, methyl ethyl ketone, toluene, ethyl acetate, and tetrahydrofuran. Such solvent provides no adverse effects on the transparent film layer in practical use such as corrosion and is capable of dissolving polyimide sufficiently.

The solvent has a boiling point of preferably 55° C. to 230° C., and more preferably 70° C. to 150° C. A solvent having a boiling point within the above ranges is selected, to thereby prevent rapid evaporation of the solvent in the polyimide solution during the drying step and provide a polyimide layer having excellent surface evenness. Examples of the solvent having a boiling point within the above ranges include ketone-based solvents such as cyclopentanone, cyclohexanone, and methyl isobutyl ketone.

The polyimide solution has any appropriate viscosity in accordance with the purpose. The viscosity is preferably 50 to 600 (mPa·s), more preferably 100 to 300 (mPa·s), and most preferably 120 to 200 (mPa·s) measured at 23° C. and a shear rate of 1,000 (1/s). A viscosity of the polyimide solution within the above ranges allows formation of a very thin polyimide layer having excellent surface evenness and optical uniformity.

A method of applying the polyimide solution is not particularly limited, and an example thereof includes a method employing any appropriate coater. Specific examples of the coater include a reverse roll coater, a positive rotation roll coater, a gravure coater, a knife coater, a rod coater, a slot orifice coater, a curtain coater, a fountain coater, an air doctor coater, a kiss coater, a dip coater, a bead coater, a blade coater, a cast coater, a spray coater, a spin coater, an extrusion coater, and a hot melt coater. Of those, a reverse roll coater, a positive rotation roll coater, a gravure coater, a rod coater, a slot orifice coater, a curtain coater, or a fountain coater is preferably used in the present invention. The application method employing the coater allows formation of a very thin polyimide layer having excellent surface evenness and optical uniformity.

An application thickness of the polyimide solution may be appropriately adjusted in accordance with the total solid content or application viscosity of the polyimide solution, and the type of coater. The application thickness is preferably 2 μm to 30 μm, more preferably 5 μm to 25 μm, and most preferably 8 μm to 22 μm. Application to such thickness can provide a polyimide layer having a desired thickness (resulting in excellent adhesiveness and adhesive durability with the polarizer) after drying. An application thickness of the polyimide solution within the above ranges allows formation of a very thin polyimide layer having excellent surface evenness and optical uniformity.

Any appropriate drying method may be employed as a method of drying the polyimide solution. Specific examples thereof include: an air-circulating thermostatic oven in which hot air or cool air circulates; a heater using microwaves or far infrared rays; a heated roller for temperature adjustment; and a heating method or temperature control method employing a heat pipe roller or a metallic belt.

A drying temperature for the polyimide solution is preferably 50° C. to 250° C., and more preferably 80° C. to 150° C. The drying may be performed at a constant temperature, or may be performed while the temperature is stepwise or continuously increased or decreased. Stepwise drying treatment allows formation of a polyimide layer having even better surface evenness. A specific example of stepwise drying treatment is a two-step drying treatment involving: primary drying at a temperature of 40° C. to 140° C. (preferably 40° C. to 120° C.) and secondary drying at 150° C. to 250° C. (preferably 150° C. to 180° C.).

Any appropriate drying time may be employed as a drying time for the polyimide solution. The drying time is preferably 1 to 20 min, more preferably 1 to 15 min, and most preferably 2 to 10 min. A drying time for the polyimide solution within the above ranges can provide a polyimide layer having excellent surface evenness.

A-5-2. Surface Modification Treatment

Any appropriate method may be employed for the surface modification treatment. The surface modification treatment may be a dry process or a wet process, for example. Specific examples of the dry process include: discharge treatment such as corona treatment or glow discharge treatment; flame treatment; ozone treatment; UV/ozone treatment; and ionized active ray treatment such as UV treatment or electron beam treatment. Of those, UV/ozone treatment, corona treatment, and/or plasma treatment is preferably used in the present invention because such treatment allows continuous production and provides excellent economical efficiency and operability.

In the specification of the present invention, the term “UV/ozone treatment” refers to treatment of a film surface involving irradiation with UV rays while an air containing ozone is blown. The term “corona treatment” refers to treatment of a film surface involving: application of high frequency and high voltage between a ground dielectric roller and an insulated electrode; electrical breakdown of air between the electrodes for ionization of air to cause corona discharge; and passage of a film through corona discharge. The term “plasma treatment” refers to treatment of a film surface involving: glow discharge in an inert gas or inorganic gas such as a oxygen gas or a halogen gas at low pressure; partial ionization of gas molecules to cause low temperature plasma; and passage of a film through plasma.

An atmosphere for performing the surface modification treatment is not particularly limited, but examples thereof include air atmosphere, nitrogen atmosphere, and argon atmosphere. A temperature of the atmosphere during the treatment is preferably 23° C. to 80° C., more preferably 23° C. to 60° C., and most preferably 23° C. to 50° C.

A time for performing the surface modification treatment is not particularly limited, but is preferably 5 sec to 10 min, more preferably 10 sec to 5 min, and most preferably 20 sec to 3 min. In the present invention, the surface modification treatment is performed such that a contact angle with water at a surface of the polyimide layer is preferably 10° to 70°, more preferably 15° to 60°, and most preferably 20° to 50°.

A typical example of the wet process includes alkali treatment. The term “alkali treatment” refers to surface treatment involving immersion of a laminate film into an alkali treatment liquid prepared by dissolving a basic substance into water or an organic solvent. As illustrated in the description of FIG. 3, the dry process and the wet process (alkali treatment) may be combined, to thereby further improve adhesiveness between the polarizer and the polyimide layer of the laminate film. Detailed reasons for the improvement are not clear, but the alkali treatment step presumably involves saponification of an outermost layer of the polyimide layer to modify polyimide into polyamic acid having a functional group, provision of unevenness on a surface of the polyimide layer to increase surface free energy, and the like.

Any appropriate substance may be employed as the basic substance. Specific examples thereof include sodium hydroxide, potassium hydroxide, calcium hydroxide, barium hydroxide, copper hydroxide, aluminum hydroxide, iron hydroxide, ammonium hydroxide, and sodium hydrogen carbonate.

The alkali treatment liquid has a pH of preferably 8 to 13, and more preferably 9 to 13. The pH can be determined through a method in accordance with JIS Z8802-1986.

The alkali treatment is preferably performed in a liquid phase such as in an aqueous solution or in an organic solvent. The alkali treatment is preferably performed in an aqueous solution from the viewpoints of economical efficiency, stability, and the like. A temperature of the liquid phase during the alkali treatment is preferably 23° C. to 80° C., more preferably 23° C. to 60° C., and most preferably 23° C. to 50° C.

A time for performing the alkali treatment is not particularly limited, but is preferably 5 sec to 10 min, more preferably 10 sec to 5 min, and most preferably 20 sec to 3 min.

Any appropriate method may be employed as a drying method after the alkali treatment. Specific examples of the drying method include: an air-circulating thermostatic oven in which hot air or cool air circulates; a heater using microwaves or far infrared rays; a heated roller for temperature adjustment; and heating methods or temperature control methods employing a heat pipe roller or a metallic belt.

A drying temperature after the alkali treatment is not particularly limited, but is preferably 30° C. to 180° C., more preferably 40° C. to 150° C., and particularly preferably 50° C. to 130° C. A drying temperature within the above ranges can sufficiently remove moisture content adhered to the surface of the laminate film.

A-5-3. Attaching of Laminate Film and Polarizer Together

The laminate film and the polarizer may be attached together through any appropriate method. For example, according to an embodiment illustrated in FIG. 5, an application liquid containing the adhesive in a predetermined ratio is applied on the surface of the polyimide layer of the laminate film. The adhesive and the polarizer are brought into contact while the adhesive remains wet, and the adhesive is dried, to thereby realize attaching. A method of applying the application liquid containing the adhesive is not particularly limited, and the above-described application method may be used. Further, application methods described in FIGS. 2 and 5 of JP 11-179871 A may also be used.

A method of attaching the laminate film and the polarizer together is not limited to the examples shown above, and any appropriate method may be employed. Specific examples thereof include hot melt lamination, non-solvent lamination, wet lamination, and dry lamination. As shown in FIG. 5, the present invention preferably employs wet lamination, which is suitable for a water-soluble adhesive.

In the specification of the present invention, the term “hot melt lamination” refers to a method involving: application of a molten hot melt adhesive or the like on one film; and attaching of the other film thereto. The term “non-solvent lamination” refers to a method involving: heating of a heat melt adhesive or the like to decrease its viscosity; application of the heat melt adhesive or the like on one film; and attaching the other film thereto through contact bonding by using a heat roller. The term “wet lamination” refers to a method involving: application of a water-soluble adhesive, an emulsion-type adhesive, or the like on one film; attaching of the other film while the adhesive remains wet; and drying of the whole in a drying oven. The term “dry lamination” refers to a method involving: application of a solvent-type adhesive or the like on one film; drying of the solvent through evaporation in a drying oven; and contact bonding of the other film thereto by using a heating roller.

An application thickness of the adhesive may be appropriately adjusted in accordance with the total solid content or application viscosity of the polyimide solution, and the type of coater. The application thickness is preferably 0.01 μm to 5 μm, more preferably 0.01 μm to 3 μm, and most preferably 0.01 μm to 1 μm. An application thickness of the adhesive within the above ranges allows formation of an adhesive layer having excellent surface evenness.

Any appropriate method may be employed as a method of drying the adhesive. Specific examples thereof include: an air-circulating thermostatic oven in which hot air or cool air circulates; a heater using microwaves or far infrared rays; a heated roller for temperature adjustment; and heating methods or temperature control methods employing a heat pipe roller or a metallic belt.

A drying temperature for the adhesive is preferably 30° C. to 180° C., more preferably 40° C. to 150° C., and most preferably 50° C. to 130° C. A drying temperature for the adhesive within the above ranges can provide an adhesive layer having excellent surface evenness.

Any appropriate drying time may be employed as a drying time for the adhesive. The drying time is preferably 1 to 20 min, more preferably 1 to 15 min, and most preferably 2 to 10 min. A drying time for the adhesive within the above ranges can provide an adhesive layer having excellent surface evenness, resulting in improvement of adhesiveness between the polyimide layer and the polarizer.

B. Liquid Crystal Panel

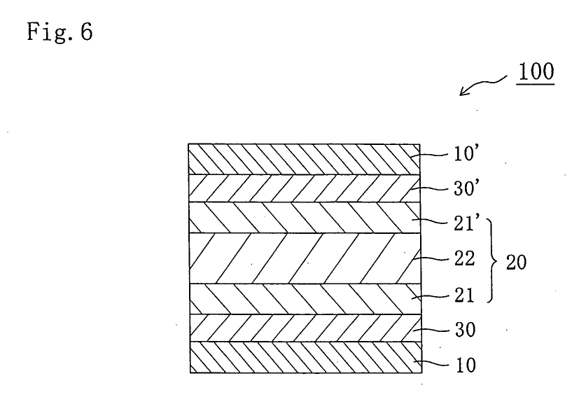

FIG. 6 is a schematic sectional view of a liquid crystal panel according to a preferred embodiment of the present invention. A liquid crystal panel 100 is provided with: a liquid crystal cell 20; retardation plates 30 and 30′ arranged on both sides of the liquid crystal cell 20; and polarizing plates 10 and 10′ arranged on outer sides of the respective retardation plates 30 and 30′. Any appropriate retardation plates may be employed as the retardation plates 30 and 30′ in accordance with the purpose and alignment mode of the liquid crystal cell. One or both of the retardation plates 30 and 30′ may be omitted in accordance with the purpose and alignment mode of the liquid crystal cell. At least one of the polarizing plates 10 and 10′ is the polarizing plate of the present invention described in the section A. The polarizing plates 10 and 10′ are typically arranged such that absorption axes of respective polarizers are perpendicular to each other. The liquid crystal cell 20 includes: a pair of glass substrates 21 and 21′; and a liquid crystal layer 22 as a display medium arranged between the substrates. One substrate (active matrix substrate) 21 is provided with: a switching element (TFT, in general) for controlling electrooptic characteristics of liquid crystals; and a scanning line for providing a gate signal to the switching element and a signal line for providing a source signal thereto (the element and the lines not shown). The other glass substrate (color filter substrate) 21′ is provided with a color filter (not shown). The color filter may be provided in the active matrix substrate 21 as well. A space (cell gap) between the substrates 21 and 21′ is controlled by a spacer (not shown). An alignment film (not shown) formed of, for example, polyimide is provided on a side of each of the substrates 21 and 21′ in contact with the liquid crystal layer 22.

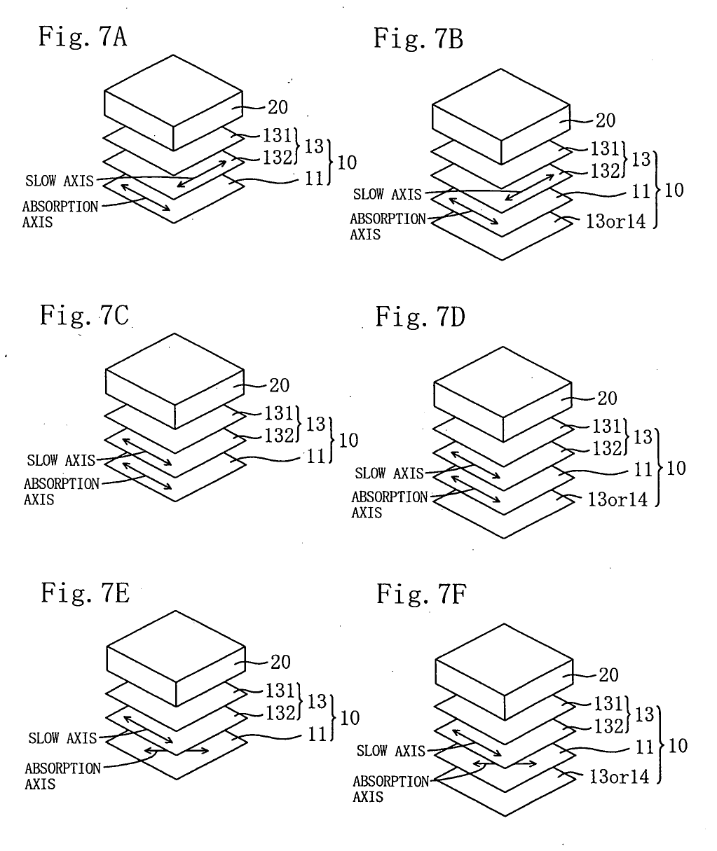

FIGS. 7A to 7F are each a schematic perspective view illustrating a typical arrangement for a polarizing plate of a liquid crystal panel of the present invention. For clarity, only lower side (backlight side) of the liquid crystal cell is described in the diagrams. However, the polarizing plate of the present invention may be obviously arranged on only upper side (viewer side) of the liquid crystal cell, or may be obviously arranged on both sides of the liquid crystal cell. Note that, in FIGS. 7A to 7F, retardation plates are omitted. In a case where the polarizing plate 10 of the present invention is used as shown in FIGS. 7A to 7F, the polarizing plate 10 is arranged such that the laminate protective film 13 is disposed between the liquid crystal cell 20 and the polarizer 11. Optical properties of the transparent film layer 131, polyimide layer 132, and anchor coat layer 133 (not shown in FIGS. 7A to 7F) of the laminate protective film 13 are optimized to provide no adverse effects on display properties of a liquid crystal display apparatus, as described above. On an outer side of the polarizer 11, the laminate protective film 13 or any appropriate protective film 14 may be arranged. The polyimide layer 132 substantially exhibits birefringence, and thus has a slow axis. The polarizer 11 and the polyimide layer 132 are arranged such that an absorption axis of the polarizer 11 and the slow axis of the polyimide layer 132 are parallel, perpendicular, or at 45° to each other. Embodiments shown in FIGS. 7A and 7B each suitably allow optical compensation of a liquid crystal cell of particularly VA mode, without use of retardation plates. Embodiments shown in FIGS. 7E and 7F each suitably allow optical compensation of a liquid crystal cell of particularly OCB mode, without use of retardation plates.

C. Application of Polarizing Plate and Liquid Crystal Panel of the Present Invention

The polarizing plate and liquid crystal panel of the present invention can be used for: a liquid crystal display apparatus; or an image display apparatus such as an organic electroluminescence display (organic EL), a projector, a projection television, or a plasma television. The liquid crystal display apparatus of the present invention may be used for various applications such as: office automation (OA) devices such as a personal computer monitor, a laptop personal computer, and a copying machine; portable devices such as a cellular phone, a watch, a digital camera, a personal digital assistance (PDA), and a portable game machine; home appliances such as a video camera, a liquid crystal television, and a microwave; in-car devices such as a back monitor, a car navigation system monitor, and a car audio; display devices such as a commercial information monitor; security devices such as a surveillance monitor; and nursing care and medical devices such as a nursing monitor and a medical monitor. In particular, the polarizing plate and liquid crystal panel of the present invention are preferably used for a liquid crystal display apparatus, and particularly preferably used for a liquid crystal television.

In particular, the polarizing plate, liquid crystal panel, and liquid crystal display apparatus of the present invention are preferably used for a large liquid crystal television. A liquid crystal television employing the polarizing plate, liquid crystal panel, and liquid crystal display apparatus of the present invention has a screen size of preferably wide 17-inch (373 mm×224 mm) or more, more preferably wide 23-inch (499 mm×300 mm) or more, particularly preferably wide 26-inch (566 mm×339 mm) or more, and most preferably wide 32-inch (687 mm×412 mm) or more.

The type of liquid crystal display apparatus is not particularly limited, and a transmissive, reflective, or transflective liquid crystal display apparatus may be used. Examples of liquid crystal cells used for the liquid crystal display apparatus include various liquid crystal cells of twisted nematic (TN) mode, super twisted nematic (STN) mode, electrically controlled birefringence (ECB) mode, vertical alignment (VA) mode, in-plane switching (IPS) mode, optically compensated bend (OCB) mode, surface stabilized ferroelectric liquid crystal (SSFLC) mode, and antiferroelectric liquid crystal (AFLC) mode. Of those, the polarizing plate and liquid crystal panel of the present invention are preferably used for the liquid crystal display apparatus of TN mode, VA mode, IPS mode, or OCB mode. The polarizing plate and liquid crystal panel of the present invention are most preferably used for the liquid crystal display apparatus of VA mode or OCB mode.

The liquid crystal cell of twisted nematic (TN) mode refers to a liquid crystal cell having nematic liquid crystals with positive dielectric anisotropy between two substrates, and has liquid crystal molecule alignment twisted by 90° through surface alignment treatment of glass substrates. Specific examples thereof include: a liquid crystal cell described in “Ekisho Jiten”, published by Baifukan Co., Ltd., p. 158, 1989; and a liquid crystal cell described in JP 63-279229 A.

The liquid crystal cell of vertical alignment (VA) mode refers to a liquid crystal cell having nematic liquid crystals with negative dielectric anisotropy vertically aligned between transparent electrodes without application of voltage, by utilizing an electrically controlled birefringence (ECB) effect. Specific examples thereof include: liquid crystal cells described in JP 62-210423 A and JP 04-153621 A. As described in JP 11-258605 A, the liquid crystal cell of VA mode may include: a liquid crystal cell provided with a slit within a pixel for expanding a viewing angle; and a liquid crystal cell of multi domain vertical alignment (MVA) mode by using a substrate having protrusions formed on a surface thereof. As described in JP 10-123576 A, the liquid crystal cell of VA mode may include a liquid crystal cell of vertically aligned twisted nematic (VATN) mode in which a chiral agent is added to liquid crystals to substantially vertically align nematic liquid crystals without application of voltage and to provide twisted multi domain alignment of the liquid crystals with application of voltage.

The liquid crystal cell of in-plane switching (IPS) mode refers to a liquid crystal cell in which homogeneously aligned nematic liquid crystals in the absence of an electric field respond in an electric field parallel to substrates (also referred to as a horizontal electric field) generated between a counter electrode and a pixel electrode each formed of metal, for example, by utilizing an electrically controlled birefringence (ECB) effect. To be specific, as described in “Monthly Display July” (p. 83 to p. 88, published by Techno Times Co., Ltd., 1997) or “Ekisho vol. 2, No. 4” (p. 303 to p. 316, published by Japanese Liquid Crystal Society, 1998), normally black mode provides completely black display in the absence of an electric field by: aligning an alignment direction of the liquid crystal cell in the absence of application of voltage with an absorption axis of one polarizer; and arranging the polarizing plates above and below the liquid crystal cell to be perpendicular to each other. Under application of an electric field, liquid crystal molecules rotate while remaining parallel with substrates, to thereby provide a light transmittance in accordance with a rotation angle. The IPS mode includes super in-plane switching (S-IPS) mode and advanced super in-plane switching (AS-IPS) mode employing a V-shaped electrode, a zigzag electrode, or the like. Examples of a commercially available liquid crystal display apparatus of IPS mode include: 20-inch wide liquid crystal television “Wooo” (trade name, manufactured by Hitachi, Ltd.); 19-inch liquid crystal display “ProLite E481S-1” (trade name, manufactured by Iiyama Corporation); and 17-inch TFT liquid crystal display “FlexScan L565” (trade name, manufactured by Eizo Nanao Corporation).

The liquid crystal cell of optically compensated bend or optically compensated birefringence (OCB) mode refers to a liquid crystal cell in which nematic liquid crystals with positive dielectric anisotropy are bend aligned (where twisted alignment exists in a central part) between transparent electrodes in the absence of application of voltage, by utilizing an electrically controlled birefringence (ECB) effect. The liquid crystal cell of OCB mode is also referred to as a “π cell”. Specific examples thereof include: a liquid crystal cell described in “Jisedai Ekisho Display”, published by Kyoritsu Shuppan Co., Ltd., p. 11 to p. 27, 2000; and a liquid crystal cell described in JP 07-084254 A.

The polarizing plate of the present invention is used for the various liquid crystal cells, to thereby improve contrast ratio, hue, and/or viewing angle properties. Further, functions of the polarizing plate can be maintained over a long period of time.

The present invention will be described in more detail by using the following examples and comparative examples. However, the present invention is not limited to the examples. Analysis methods used in the examples are described below.

(1) Reagents:

2,2′-bis(3,4-dicarboxyphenyl)-hexafluoropropane dianhydride available from Clariant (Japan) K.K. was used. 2,2-bis(trifluoromethyl)-4,4′-diaminobiphenyl available from Wakayama Seika Kogyo Co., Ltd. was used. Other chemicals were purchased from Wako Pure Chemical Industries, Ltd. and were used as they were.

(2) Method of Measuring Imidation Rate:

The imidation rate was determined by: measuring an integrated intensity (as X) of a peak of a proton derived from NH of polyamic acid at about 11 ppm and an integrated intensity (as Y) of a peak of a proton derived from an aromatic ring of polyamic acid and polyimide at 7.0 to 8.5 ppm by using an ¹H-NMR apparatus “LA400” (trade name, available from JEOL Ltd.); and using an equation A(%)=((Y−6×)/Y)×100.

(3) Method of Measuring Molecular Weight of Polyimide:

The molecular weight of polyimide was calculated through a gel permeation chromatograph (GPC) method by using polyethylene oxide as a standard sample. To be specific, the molecular weight of polyimide was measured under the following measurement conditions by using the following apparatus and instruments.

Measurement sample: A sample resin was dissolved in an eluant to prepare a 0.1 wt % solution.

Pretreatment: The solution was left standing for 8 hours, and filtered through a 0.45 μm membrane filter.

Analyzer: “HLC-8020GPC”, manufactured by Tosoh Corporation

Column: GMH_{XL}+GMH_{XL}+G2500H_{XL}, manufactured by Tosoh Corporation

Column size: 7.8 mmΦ×30 cm each (total of 90 cm)

Eluant: dimethylformamide (1 L of a dimethylformamide solution prepared by: adding 10 mM lithium bromide and 10 mM phosphoric acid; and filling up a 1 L volumetric flask).

Flow rate: 0.8 ml/min

Detector: RI (differential refractometer)

Column temperature: 40° C.

Injection amount: 100 μl

(4) Method of Measuring Moisture Content of Polarizer or Polarizing Plate

The moisture content was measured by using a Karl Fischer moisture meter “MKA-610” (trade name, manufactured by Kyoto Electronics Manufacturing Co., Ltd.). A polarizing plate cut out into a size of 10 mm×30 mm was charged into a heating furnace at 150° C.±1° C., and a nitrogen gas (200 mL/min) was bubbled into a solution in a titration cell for measurement.

(5) Method of Measuring Single Axis Transmittance, Degree of Polarization, and Δab Value of Polarizing Plate:

The single axis transmittance, degree of polarization, and Δab value of the polarizing plate were measured at 23° C. by using a spectrophotometer “DOT-3” (trade name, manufactured by Murakami Color Research Laboratory).

(6) Method of Measuring Refractive Index of Film:

The refractive index was measured by using an Abbe refractometer “DR-M4” (trade name, manufactured by Atago Co., Ltd.) by using light of a wavelength of 589 nm at 23° C.

(7) Method of Measuring Retardation Values (Re[590], Rth[590]):

The retardation values were measured by using an automatic birefringence analyzer (“KOBRA-21ADH”, trade name, manufactured by Oji Scientific Instruments) based on a parallel Nicol rotation method by using light of a wavelength of 590 nm at 23° C.

(8) Method of Measuring Light Transmittance:

The light transmittance was measured by using a UV-vis spectrophotometer “V-560” (trade name, manufactured by JASCO Corporation) by using light of a wavelength of 590 nm at 23° C.

(9) Method of Measuring Photoelastic Coefficient:

The retardation values (23° C./wavelength of 590 nm) of a sample having a size of 2 cm×10 cm were measured under stress (5 to 15 N) by using a spectroscopic ellipsometer “M-220” (trade name, manufactured by JASCO Corporation), and the photoelastic coefficient was calculated from a slope of a function of the stress and retardation values.

(10) Method of Measuring Thickness:

A thickness of less than 10 μm was measured by using a thin film thickness spectrophotometer “multichannel photodetector (MCPD-2000)” (trade name, manufactured by Otsuka Electronics Co., Ltd.). A thickness of 10 μm or more was measured by using a digital micrometer “K-351C-type” (trade name, manufactured by Anritsu Corporation).

(11) Method of Measuring Water Contact Angle:

The water contact angle was measured through a drop method by using a contact angle meter “CA-X” (trade name, manufactured by Kyowa Interface Science Co., LTD.).

(12) Hot Water Test at 60° C.:

A sample was immersed in a thermostatic water tank at 60° C.±1° C. for 5 hours, taken out of the tank, and naturally dried at normal temperatures. A peeling state between the protective film and the polarizer was visually observed. In Table 3, “good” refers to a state of the protective film and the polarizer without peeling or floating across the entire surface, and “poor” refers to a state of the protective film and the polarizer peeled off across the entire surface and a state of the polarizer degraded.

(13) Test at 60° C. and 90% RH:

A sample was left standing in a testing instrument in an environment of 60° C.±1° C. and 90±5% RH for 200 hours, and naturally cooled to normal temperatures. Various optical properties of the sample were measured after the test, and changes from before the test were determined.

(14) Heating Test at 80° C.:

A sample was left standing in an air circulating thermostatic oven at 80° C.±1° C. for 200 hours, and naturally cooled to normal temperatures. Various optical properties of the sample were measured after the test, and changes from before the test were determined.

(15) Light Resistance Test:

A sample (a polarizing plate) was irradiated with UV rays at a light intensity of 50 mW/cm² at a wavelength of 365 nm for 200 hours from a side having the laminate film attached in accordance with JIS A1415-1999 (using UV carbon arc lamp), and a state of the polarizing plate (laminate film side) was visually observed. In Table 3, “good” refers to a state where no changes were observed in the laminate film from before the test, and “poor” refers to a state where a polyimide layer had cracks formed thereon and was degraded.

(16) Abrasion Resistance Test:

A surface of a polarizing plate (laminate film side) was scratched 20 times with steel wool under a load of 10 g/cm², and damages on the surface were observed. In Table 3, “good” refers to a polarizing plate with hardly observed slight damages and a small damaged area, and “poor” refers to a polarizing plate with deep, highly visible damages and a large damaged area.

(17) Method of Measuring Contrast Ratio of Liquid Crystal Display Apparatus:

Y values were measured in a dark room at 23° C. by using the measurement apparatus “EZ Contrast 160D” (trade name, manufactured by ELDIM SA). More specifically, a white image and a black image were displayed on a liquid crystal display apparatus, and Y values of an XYZ display system in a normal direction (polar angle of 0°) and an oblique direction (azimuth angle of 45° and polar angle of 60°) of a display screen were measured by using “EZ Contrast 160D”. A contrast ratio “YW/YB” in an oblique direction was calculated from a Y value (YW) of the white image and a Y value (YB) of the black image.

### REFERENCE EXAMPLE 1

Polyimide Synthesis

17.77 g (40 mmol) of 2,2′-bis(3,4-dicarboxyphenyl)-hexafluoropropane dianhydride and 12.81 g (40 mmol) of 2,2-bis(trifluoromethyl)-4,4′-diaminobiphenyl were charged into a reaction vessel (500 mL) equipped with a mechanical stirrer, a Dean-Stark device, a nitrogen introducing tube, a thermometer, and a cooling tube. Next, a solution prepared by dissolving 2.58 g (20 mmol) of isoquinoline in 275.21 g of m-cresol was added thereto, and the mixture was stirred (600 rpm) at 23° C. for 1 hour, to thereby obtain a homogeneous solution. Next, the reaction vessel was heated by using an oil bath such that inside temperature of the reaction vessel reached 180° C.±3° C., and the solution was stirred for 5 hours while keeping the temperature at 180° C.±3° C., to thereby obtain a yellow solution. The solution was stirred for additional 3 hours, and then heating and stirring were stopped. The solution was left standing to cool to room temperature, and a gel product of a polymer precipitated.

Acetone was added to the yellow solution in the reaction vessel, to thereby completely dissolve the gel product and produce a diluted solution (7 wt %). The diluted solution was gradually added to 2 L of isopropyl alcohol under continuous stirring. White powder precipitated, and was collected by filtration. The white powder was added to 1.5 L of isopropyl alcohol for washing. The same procedure was repeated for washing the white powder, and the white powder was collected by filtration again. The white powder was dried in an air circulating thermostatic oven at 60° C. for 48 hours, and then dried at 150° C. for 7 hours, to thereby obtain polyimide containing a repeating unit represented by the below-indicated formula (1) (yield of 85%) as white powder. Polyimide had a weight average molecular weight (Mw) of 124,000 and an imidation rate of 99.9%.

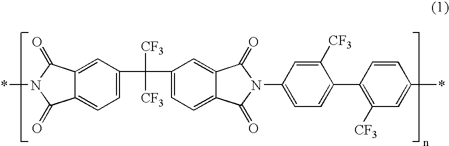

### REFERENCE EXAMPLE 2

Production of Transparent Film

A commercially available triacetyl cellulose film “FUJITAC UZ” (trade name, available from Fuji Photo Film Co., Ltd.) having a thickness of 80 μm was used. An organic solvent-based dispersion “VYLON UR1700” (trade name, solid content of 30 wt %, available from Toyobo Co., Ltd.) of a thermoplastic resin containing as a main component modified polyester prepared through copolymerization of polyurethane and polyester was applied on a surface of the triacetyl cellulose film in one direction by using a rod coater. The whole was dried in an air circulating thermostatic oven at 130° C.±1° C. for 5 min, to thereby form an anchor coat layer having a thickness of 0.8 μm on one side of the triacetyl cellulose film. The triacetyl cellulose film including the anchor coat layer had Re[590] of 0.2 nm, Rth[590] of 60.1 nm, a light transmittance of 90% measured by using light of a wavelength of 590 nm, and an absolute value of photoelastic coefficient of 1.78×10⁻¹¹ (m²/N) measured by using light of a wavelength of 590 nm.

### REFERENCE EXAMPLE 3

Production of Polarizer

A polymer film “9P75R” (trade name, thickness of 75 μm, average degree of polymerization of 2,400, degree of saponification of 99.9 mol %, available from Kuraray Co., Ltd.) containing as a main component polyvinyl alcohol was uniaxially stretched 2.5 times by using a roll stretching machine while the polymer film was colored in a coloring bath maintained at 30° C.±3° C. and containing a mixture of iodine and potassium iodide. Next, the polyvinyl alcohol film was uniaxially stretched to a 6 times length of the original length in a bath maintained at 60° C.±3° C. and containing an aqueous solution of a mixture of boric acid and potassium iodide while a crosslinking reaction was performed. The obtained film was dried in an air circulating thermostatic oven at 50° C.±1° C. for 30 min, to thereby obtain a polarizer having a moisture content of 26% and a thickness of 28 μm.

### EXAMPLE 1

Production of Laminate Film

17.7 parts by weight of polyimide (white powder) obtained in Reference Example 1 was dissolved in 100 parts by weight of methyl isobutyl ketone (boiling point of 116° C.), to thereby prepare a 15 wt % polyimide solution. The polyimide solution was applied on a surface of the anchor coat layer formed on a transparent film and produced in Reference Example 2 in one direction by using a rod coater. Next, the whole was dried in an air circulating thermostatic oven at 135° C.±1° C. for 5 min for evaporation of a solvent, to thereby produce a transparent film (total thickness of 83.8 μm) including a polyimide layer (thickness of 3.0 μm). Then, the transparent film including the polyimide layer was uniaxially stretched 1.19 times in a width direction by using a tenter stretching machine and fixing a longitudinal direction of the film while the transparent film was heated in an air circulating thermostatic oven at 150° C.±1° C. Then, the transparent film was subjected to relaxation treatment at 0.97 times in a width direction, to thereby produce a laminate film A. Table 1 shows the properties of the laminate film before and after stretching. The properties of the polyimide layer in Table 1 were measured by using the polyimide layer peeled off from the laminate film. Table 1 clearly shows that the polyimide layer before stretching may also serve as a negative C plate, and the polyimide layer after stretching may also serve as a biaxial retardation film.

TABLE 1

| | Before stretching | | After stretching | |
|---|---|---|---|---|
| | Laminate | Polyimide | Laminate | Polyimide |
| | film | layer | film | layer |
| Thickness (μm) | 83.8 | 3.0 | 83.0 | 2.8 |
| Light | 90 | 91 | 90 | 91 |
| transmittance (%) | | | | |
| Re[590] (nm) | 0.2 | 0.0 | 55.0 | 53.4 |
| Rth[590] (nm) | 185.0 | 124.9 | 245.0 | 184.9 |
| Δn[xz] | 0.0022 | 0.042 | 0.0030 | 0.066 |
| Variation in | | | | ±0.5 |
| alignment angle (°) | | | | |
| Amount of residual | | 5.0 | | 2.0 |
| volatile component | | | | |
| (wt %) | | | | |

Surface Modification Treatment

The surface of the polyimide layer of the laminate film A was subjected to surface modification treatment at 23° C. for 10 min in an air atmosphere by using a parallel ray-type UV/ozone treatment apparatus (manufactured by EYE GRAPHICS Co., Ltd.) equipped with a metal halide lamp (light intensity of 200 mJ/cm² at a wavelength of 365 nm) as a light source. Next, the laminate film was immersed in an aqueous solution of sodium hydroxide (40° C., pH of 13) for 30 sec for alkali treatment. A water contact angle of the polyimide layer of the laminate film A changed from 80° before the surface modification treatment to 30° after the surface modification treatment.

Production of Polarizing Plate

Next, 39.8 parts by weight (solid content of 2.79 parts by weight) of an adhesive “GOHSEFIMER Z200” (trade name, solid content of 7 wt % aqueous solution, available from Nippon Synthetic Chemical Industry Co., Ltd.) containing as a main component modified vinyl alcohol having an acetoacetyl group, 0.62 part by weight (solid content of 0.42 part by weight) of a crosslinking agent “WATERSOL S-695” (trade name, available from Dainippon Ink and Chemicals, Incorporated) containing as a main component a methylol compound, and pure water were mixed, to thereby prepare a 4.0 wt % aqueous solution. Then, the aqueous solution was applied on both surfaces of the polarizer produced in Reference Example 3 by using a rod coater to a thickness of 0.05 μm after drying. The laminate film A was laminated through the adhesive on one side of the polarizer such that the surface of the polyimide layer opposed the polarizer. A commercially available triacetyl cellulose film “FUJITAC-UZ” (trade name, available from Fuji Photo Film Co., Ltd.) was laminated through the adhesive on the other side of the polarizer. Then, the polarizing plate was dried in an air circulating thermostatic oven at 110° C.±1° C. for 5 min, to thereby produce a polarizing plate A. Table 2 collectively shows the properties of the obtained polarizing plate A and the results of Examples 2 to 6 and Comparative Example 1 described below. Note that, an absorption axis of the polarizer and a slow axis of the polyimide layer were perpendicular to each other, and an angle actually formed between the absorption axis of the polarizer and the slow axis of the polyimide layer was 90°±0.5°.

TABLE 2

| | Example | Example | Example | Example | Example | Example | Example | Comparative |
|---|---|---|---|---|---|---|---|---|
| | 1 | 2 | 3 | 4 | 5 | 6 | 7 | Example 1 |
| Thickness of | 191.1 | 191.1 | 191.1 | 231.1 | 161.1 | 197.5 | 201.9 | 191.1 |
| polarizing | | | | | | | | |
| plate (μm) | | | | | | | | |
| Thickness of | 2.8 | 2.8 | 2.8 | 2.8 | 2.8 | 9.0 | 12.0 | 2.8 |
| polyimide layer | | | | | | | | |
| (μm) | | | | | | | | |
| Moisture | 5.0 | 5.0 | 5.0 | 5.0 | 5.0 | 5.0 | 5.0 | 5.0 |
| content of | | | | | | | | |
| polarizing | | | | | | | | |
| plate (wt %) | | | | | | | | |
| Single axis | 43.46 | 43.42 | 43.40 | 43.42 | 43.41 | 43.42 | 43.41 | 43.43 |
| transmittance | | | | | | | | |
| (%) | | | | | | | | |
| Degree of | 99.99 | 99.99 | 99.99 | 99.99 | 99.99 | 99.99 | 99.98 | 99.98 |
| polarization | | | | | | | | |
| (%) | | | | | | | | |
| Perpendicular | 3.90 | 3.91 | 3.90 | 3.92 | 3.20 | 4.33 | 4.65 | 3.91 |
| Δab value (%) | | | | | | | | |
| Re[590] of | 53.4 | 53.4 | 53.4 | 53.4 | 53.4 | 152.9 | 173.1 | 53.4 |
| polyimide layer | | | | | | | | |
| (nm) | | | | | | | | |
| Rth[590] of | 184.9 | 184.9 | 184.9 | 184.9 | 184.9 | 495.9 | 532.2 | 184.9 |
| polyimide layer | | | | | | | | |
| (nm) | | | | | | | | |

Durability Test of Polarizing Plate

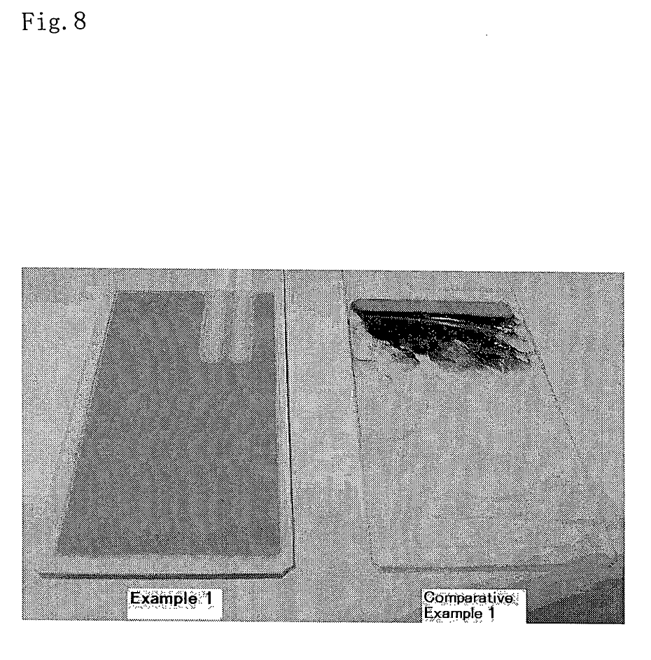

A sample was prepared by attaching the polarizing plate A cut out into a size of 25 mm×50 mm to a slide glass through an acrylic adhesive such that the surface of the laminate film opposed the surface of the slide glass. Then, the sample was subjected to various durability tests such as hot water test at 60° C., test at 60° C. and 90% RH, heating test at 80° C., light resistance test, and abrasion resistance test. Table 3 collectively shows the results of Example 1 and the results of Examples 2 to 6 and Comparative Example 1 described below. FIG. 8 collectively shows the results of the hot water test at 60° C. of Example 1 with the results of Comparative Example 1.

TABLE 3

| | Example | Example | Example | Example | Example | Example | Example | Comparative |
|---|---|---|---|---|---|---|---|---|
| | 1 | 2 | 3 | 4 | 5 | 6 | 7 | Example 1 |
| Thickness of polyimide | 2.8 | 2.8 | 2.8 | 2.8 | 2.8 | 9.0 | 12.0 | 2.8 |
| layer (μm) | | | | | | | | |
| [Hot water test at 60° C.] | Good | Good | Good | Good | Good | Good | No good | No good |
| Peeling state | (Photograph) | | | | | | | (Photograph) |
| [Test at 60° C. and 90% RH] | +0.3 | +0.3 | +0.3 | +0.4 | +0.3 | +0.3 | +0.4 | +0.9 |
| Change in single axis | | | | | | | | |
| transmittance of | | | | | | | | |
| polarizing plate (%) | | | | | | | | |
| [Test at 60° C. and 90% RH] | −0.01 | −0.01 | −0.01 | −0.01 | −0.01 | −0.01 | −0.01 | −0.04 |
| Change in degree of | | | | | | | | |
| polarization of | | | | | | | | |
| polarizing plate (%) | | | | | | | | |
| [Test at 60° C. and 90% RH] | +0.4 | +0.4 | +0.4 | +0.4 | +0.4 | +0.7 | +0.8 | +1.2 |
| Change in perpendicular | | | | | | | | |
| Δab value of polarizing | | | | | | | | |
| plate (%) | | | | | | | | |
| [Heating test at 80° C.] | +1.0 | +1.0 | +1.0 | +1.0 | +0.2 | +2.7 | +3.2 | +4.0 |
| Change in Re[590] of | | | | | | | | |
| polyimide layer | | | | | | | | |
| [Heating test at 80° C.] | +4.0 | +4.0 | +4.0 | +5.0 | −1.0 | +12 | +17 | +20 |
| Change in Rth[590] of | | | | | | | | |
| polyimide layer | | | | | | | | |
| [Light resistance test] | Good | Good | Good | Good | Good | Good | Good | No good |
| State of polarizing plate | | | | | | | | |
| (laminate film side) | | | | | | | | |
| Abrasion resistance of | Good | Good | Good | Good | Good | Good | Good | No good |
| polarizing plate | | | | | | | | |
| (laminate film side) | | | | | | | | |

### EXAMPLE 2

A polarizing plate B was produced in the same manner as in Example 1 except that the surface modification treatment was changed from UV/ozone treatment to corona treatment. Table 2 shows the properties of the polarizing plate B. Next, various durability tests were performed in the same manner as in Example 1, and Table 3 shows the results. Note that, the surface of the polyimide layer was subjected to corona treatment by using a corona treatment apparatus (manufactured by Kasuga Electric Works Ltd.) at a light intensity of 4,000 J/cm² and in an air atmosphere at 23° C.

### EXAMPLE 3

A polarizing plate C was produced in the same manner as in Example 1 except that the surface modification treatment was changed from UV/ozone treatment to plasma treatment. Table 2 shows the properties of the polarizing plate c. Next, various durability tests were performed in the same manner as in Example 1, and Table 3 shows the results. Note that, the surface of the polyimide layer was subjected to plasma treatment by using a plasma treatment apparatus (manufactured by Air Water Inc.) in a nitrogen atmosphere at 23° C. for 30 sec.

### EXAMPLE 4

A transparent film D was produced in the same manner as in Reference Example 2 except that the commercially available triacetyl cellulose film of Reference Example 2 was changed to a film (thickness of 120 μm) formed through a solvent casting method. The film was formed by using a cellulose-based resin (produced in accordance with Example 1 of JP 2001-188128 A) containing as a main component a mixed organic acid ester having a degree of acectyl substitution of 2.0 and a degree of propionyl substitution of 0.8 and having hydroxide groups of cellulose substituted partly by an acetyl group and partly by a propionyl group. The transparent film D was used, and a polarizing plate D was produced in the same manner as in Example 1. Table 2 shows the properties of the polarizing plate D. Next, various durability tests were performed in the same manner as in Example 1, and Table 3 shows the results. The transparent film D had Re[590] of 2.5 nm, Rth[590] of 107 nm, a light transmittance of 90% by using light of a wavelength of 590 nm, and an absolute value of photoelastic coefficient of 2.1×10⁻¹¹ (m²/N) by using light of a wavelength of 590 nm.

### EXAMPLE 5

A transparent film E was produced in the same manner as in Reference Example 2 except that the commercially available triacetyl cellulose film of Reference Example 2 was changed to a film (thickness of 50 μm) formed through an extrusion method. The film was formed by using a norbornene-based resin (produced in accordance with Example 1 of JP 62-252406 A) containing as a main component an addition polymer of norbornene and ethylene. The transparent film E was used, and a polarizing plate E was produced in the same manner as in Example 1. Table 2 shows the properties of the polarizing plate E. Next, various durability tests were performed in the same manner as in Example 1, and Table 3 shows the results. The transparent film E had Re[590] of 5.0 nm, Rth[590] of 6.0 nm, a light transmittance of 92% by using light of a wavelength of 590 nm, and an absolute value of photoelastic coefficient of 4.8×10⁻¹² (m²/N) by using light of a wavelength of 590 nm.

### EXAMPLE 6

A polarizing plate F was produced in the same manner as in Example 1 except that the thickness of the polyimide layer of the laminate film (after stretching) was changed to 9.0 μm. Table 2 shows the properties of the polarizing plate F. Next, various durability tests were performed in the same manner as in Example 1, and Table 3 shows the results.

### EXAMPLE 7

A polarizing plate G was produced in the same manner as in Example 1 except that the thickness of the polyimide layer of the laminate film (after stretching) was changed to 12.0 μm. Table 2 shows the properties of the polarizing plate G. Next, various durability tests were performed in the same manner as in Example 1, and Table 3 shows the results.

### COMPARATIVE EXAMPLE 1

A polarizing plate H was produced in the same manner as in Example 1 except that the laminate film A was laminated such that the surface opposite to the surface having the polyimide layer (surface of the transparent film of the laminate film) opposed the polarizer. Table 2 shows the properties of the polarizing plate H. Next, various durability tests were performed in the same manner as in Example 1, and Table 3 shows the results. Further, FIG. 8 shows the results of the hot water test at 60° C.

### EXAMPLE 8

A liquid crystal panel was taken out of a commercially available liquid crystal display apparatus “32-inch TH-32LX10” (manufactured by Matsushita Electric Industrial Co., Ltd.) including a liquid crystal cell of VA mode. Polarizing plates arranged above and below the liquid crystal cell were removed, and glass surfaces (front and back surfaces) were washed. Next, the polarizing plate of Example 1 was attached to a backlight side of the liquid crystal cell through an acrylic adhesive such that an absorption axis of the polarizer and a short side of the liquid crystal panel were parallel to each other, and such that the absorption axis of the polarizer and a slow axis of the laminate film were perpendicular to each other. Then, a commercially available polarizing plate “NPF-SEG1224DU” (trade name, manufactured by Nitto Denko Corporation) was attached to a viewer side of the liquid crystal panel through an acrylic adhesive such that the absorption axis of the polarizer and a long side of the liquid crystal panel were parallel to each other, and such that the absorption axis of the polarizer on a backlight side and the absorption axis of the polarizer on a viewer side were perpendicular to each other. An angle actually formed between the upper and lower absorption axes of the liquid crystal cell was 90°±1.0°. The thus-produced liquid crystal panel was incorporated into the original liquid crystal display apparatus, and backlight was turned on for 10 min, to thereby measure display properties. Table 4 collectively shows the results of Example 8 with the results of Comparative Example 2 described below.

### COMPARATIVE EXAMPLE 2

Display properties of the commercially available liquid crystal display apparatus “32-inch TH-32LX10” (manufactured by Matsushita Electric Industrial Co., Ltd.) used in Example 8 were measured. Table 4 shows the results.

TABLE 4

| | | Comparative |
|---|---|---|
| | Example 8 | Example 2 |
| Contrast ratio in normal direction (polar | 593.6 | 421.0 |
| angle of 0°) | | |
| Contrast ratio in oblique direction | 32.1 | 15.6 |
| (polar angle of 60°/azimuth angle of 45°) | | |

[Evaluation]

The polarizing plate of the present invention employed, as a protective film for a polarizer, the laminate protective film including a polyimide layer on one side of the transparent film layer. Further, the laminate protective film was laminated such that the surface of the polyimide layer of the laminate protective film opposed one side of the polarizer, thereby causing no peeling or floating between the polarizer and the polyimide layer even after the hot water test at 60° C. In contrast, the polarizing plate of Comparative Example 1 had significant peeling between the polarizer and the protective film after the hot water test at 60° C. The results reveal that the polarizer and the polyimide layer were laminated adjacently through an adhesive layer (that is, the polyimide layer was laminated on inner side of the transparent film layer), to thereby significantly improve durability in a high temperature and high humidity environment. The polarizing plate of the present invention had small change in light transmittance, degree of polarization, and hue in a high temperature and high humidity environment. In contrast, optical properties of the polarizing plate of Comparative Example 1 such as light transmittance, degree of polarization, and hue were significantly reduced due to degradation of the polarizer in a high temperature and high humidity environment.

In the polarizing plate of the present invention, the polyimide layer was protected by the transparent film layer and was not exposed to outside air, and thus had small change in retardation values in a high temperature environment. The transparent film layer exposed to outside air was hardly damaged compared with the polyimide layer, and the surface of the polyimide layer was favorably protected from damages in the abrasion resistance test. In contrast, in the polarizing plate of Comparative Example 1, the polyimide layer was exposed to outside air, and thus had large change in retardation values in a high temperature environment. Further, the surface of the polyimide layer was deeply damaged in the abrasion resistance test.

Table 3 (in particular, comparison of results of Examples 6 and 7) reveals that the polyimide layer is preferably as thin as possible. In particular, the results of Examples 6 and 7 indicate that the polyimide layer having a thickness of more than 10 μm provide drastic deteriorations in peeling state in the hot water test at 60° C., Δab value, Re, and Rth of the polarizing plate. The results suggest that a critical thickness of the polyimide layer exists around 10 μm.

The polarizing plate and liquid crystal panel of the present invention have excellent durability and thus may suitably be used for a liquid crystal display apparatus used in various environments.

Many other modifications will be apparent to and be readily practiced by those skilled in the art without departing from the scope and spirit of the invention. It should therefore be understood that the scope of the appended claims is not intended to be limited by the details of the description but should rather be broadly construed.

What is claimed is:

1. A polarizing plate comprising a polarizer and a protective film attached to at least one side of the polarizer through an adhesive layer, wherein:
the protective film comprises a laminate film including a transparent film layer and a polyimide layer; and
the polarizer and the protective film are attached together such that the polyimide layer opposes the polarizer.

2. A polarizing plate according to claim 1, wherein the polarizer comprises a stretched polymer film containing as a main component a polyvinyl alcohol-based resin, which contains a dichromatic substance.

3. A polarizing plate according to claim 1, wherein the transparent film layer comprises a polymer film containing as a main component a cellulose-based resin.

4. A polarizing plate according to claim 1, wherein the protective film further comprises an anchor coat layer between the transparent film layer and the polyimide layer.

5. A polarizing plate according to claim 1, wherein the polyimide layer has a thickness of 1 to 10 μm.

6. A polarizing plate according to claim 1, wherein the polyimide layer comprises a film containing as a main component fluorine-containing polyimide.

7. A polarizing plate according to claim 6, wherein the fluorine-containing polyimide comprises polyimide containing a repeating unit represented by the formula (1):

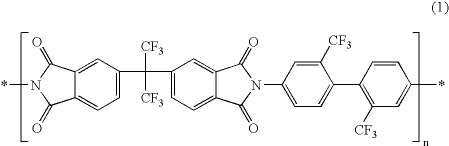

8. A polarizing plate according to claim 1, wherein the polyimide layer has a light transmittance of 90% or more measured by using light of a wavelength of 590 nm at 23° C.

9. A polarizing plate according to claim 5, wherein the polyimide layer has a thickness direction retardation value Rth[590] of 50 to 800 nm measured by using light of a wavelength of 590 nm at 23° C.

10. A polarizing plate according to claim 1, wherein the adhesive layer comprises a water-soluble adhesive containing as a main component modified polyvinyl alcohol having an acetoacetyl group.

11. A polarizing plate according to claim 5, wherein the adhesive layer comprises a water-soluble adhesive containing as a main component modified polyvinyl alcohol having an acetoacetyl group.

12. A method of producing a polarizing plate comprising the steps of:
applying a polyimide solution on a surface of a transparent film and drying the whole, so as to obtain a laminate film including a transparent film layer and a polyimide layer; and
attaching the laminate film and a polarizer together through an adhesive such that the polyimide layer opposes the polarizer.

13. A method of producing a polarizing plate according to claim 12, further comprising the step of subjecting a surface of the polyimide layer to modification treatment between the step of obtaining a laminate film and the step of attaching the laminate film and a polarizer together.

14. A method of producing a polarizing plate according to claim 13, wherein the surface modification treatment comprises at least one of corona treatment, glow discharge treatment, flame treatment, ozone treatment, UV/ozone treatment, UV treatment, and alkali treatment.

15. A method of producing a polarizing plate according to claim 12, wherein the adhesive comprises a water-soluble adhesive containing as a main component modified polyvinyl alcohol having an acetoacetyl group.

16. A method of producing a polarizing plate according to claim 12, wherein the polyimide layer is formed to have a thickness of 1 to 10 μm.

17. A liquid crystal panel comprising: the polarizing plate according to claim 1; and a liquid crystal cell.

18. A liquid crystal panel according to claim 17, wherein the liquid crystal cell is of TN mode, VA mode, IPS mode, or OCB mode.

19. A liquid crystal television comprising the liquid crystal panel according to claim 14.

20. A liquid crystal display apparatus comprising the liquid crystal panel according to claim 14.
